(19) United States
(12) Patent Application Publication
(10) Pub. No.: US 2025/0227489 A1
(43) Pub. Date: Jul. 10, 2025

(54) AGGREGATION FACTOR ADAPTATION FOR DIRECTIONAL COMMUNICATION

(71) Applicant: QUALCOMM Incorporated, San Diego, CA (US)

(72) Inventors: Ahmed Attia ABOTABL, San Diego, CA (US); Hung Dinh LY, San Diego, CA (US); Abdelrahman Mohamed Ahmed Mohamed IBRAHIM, San Diego, CA (US)

(21) Appl. No.: 18/405,114

(22) Filed: Jan. 5, 2024

(51) Int. Cl. H04W 16/28; H04W 72/23

(52) U.S. Cl. CPC H04W 16/28; H04W 72/23

(57) ABSTRACT

Methods, systems, and devices for wireless communications are described. A user equipment (UE) may receive a control message from a network entity that indicates one or more aggregation factor values. The control message may indicate one or more identifiers associated with the one or more aggregation factor values. The UE may receive information from the network entity that is indicative of a parameter associated with a directional communication between the UE and the network entity. The parameter may correspond to an aggregation factor value or to an identifier associated with the aggregation factor value. The UE may communicate with the network entity in accordance with the aggregation factor value based receiving the information indicative of the parameter.

### INTRODUCTION

The following relates to wireless communications, including managing aggregation factors for wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication by a user equipment (UE) is described. The method may include receiving a control message that indicates one or more aggregation factor values, receiving information indicative of a parameter associated with a directional communication between the UE and a network entity, the parameter corresponding to an aggregation factor value of the one or more aggregation factor values, and communicating with the network entity in accordance with the aggregation factor value based on the parameter associated with the directional communication.

An apparatus for wireless communication at a UE is described. The apparatus may include one or more memories and one or more processors coupled with the one or more memories. The one or more processors may be configured to cause the UE to receive a control message that indicates one or more aggregation factor values, receive information indicative of a parameter associated with a directional communication between the UE and a network entity, the parameter corresponding to an aggregation factor value of the one or more aggregation factor values, and communicate with the network entity in accordance with the aggregation factor value based on the parameter associated with the directional communication.

Another apparatus for wireless communication at a UE is described. The UE may include means for receiving a control message that indicates one or more aggregation factor values, means for receiving information indicative of a parameter associated with a directional communication between the UE and a network entity, the parameter corresponding to an aggregation factor value of the one or more aggregation factor values, and means for communicating with the network entity in accordance with the aggregation factor value based on the parameter associated with the directional communication.

A non-transitory computer-readable medium storing code for wireless communication is described. The code may include instructions executable by one or more processors to cause the UE to receive a control message that indicates one or more aggregation factor values, receive information indicative of a parameter associated with a directional communication between the UE and a network entity, the parameter corresponding to an aggregation factor value of the one or more aggregation factor values, and communicate with the network entity in accordance with the aggregation factor value based on the parameter associated with the directional communication.

Some examples of the method, apparatus, and non-transitory computer-readable medium described herein may further include operations, features, means, or instructions for receiving, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

In some examples of the method, apparatus, and non-transitory computer-readable medium described herein, each identifier of the one or more identifiers corresponds to a respective transmission configuration indication state identifier of a set of multiple transmission configuration indication state identifiers.

In some examples of the method, apparatus, and non-transitory computer-readable medium described herein, each identifier of the one or more identifiers corresponds to a respective set of transmission configuration indication state identifiers of a set of multiple transmission configuration indication state identifiers that includes the transmission configuration indication state identifier.

Some examples of the method, apparatus, and non-transitory computer-readable medium described herein may further include operations, features, means, or instructions for receiving, via the control message, an indication of a default aggregation factor value, the one or more aggregation factor values including the default aggregation factor value, and the default aggregation factor value corresponding to one or more second transmission configuration indication state identifiers that may be not associated with any of the one or more identifiers.

Some examples of the method, apparatus, and non-transitory computer-readable medium described herein may further include operations, features, means, or instructions for receiving, via the control message, a transmission configuration indication state element, the transmission configuration indication state element including a field that indicates the aggregation factor value, the parameter associated with a transmission configuration indication state provided by the transmission configuration indication state element.

Some examples of the method, apparatus, and non-transitory computer-readable medium described herein may further include operations, features, means, or instructions for receiving, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Some examples of the method, apparatus, and non-transitory computer-readable medium described herein may further include operations, features, means, or instructions for receiving, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Some examples of the method, apparatus, and non-transitory computer-readable medium described herein may further include operations, features, means, or instructions for receiving, via the control message, an indication of an activation of one or more transmission configuration indication states, the parameter associated with a transmission configuration indication state of the one or more transmission configuration indication states.

In some examples of the method, apparatus, and non-transitory computer-readable medium described herein, the control message includes an activation medium access control (MAC)-control element (MAC-CE).

Some examples of the method, apparatus, and non-transitory computer-readable medium described herein may further include operations, features, means, or instructions for receiving, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

In some examples of the method, apparatus, and non-transitory computer-readable medium described herein, each identifier of the one or more identifiers corresponds to a respective sounding reference signal resource indicator identifier of a set of multiple sounding reference signal resource indicator identifiers.

In some examples of the method, apparatus, and non-transitory computer-readable medium described herein, each identifier of the one or more identifiers corresponds to a respective sounding reference signal resource indicator power control identifier of a set of multiple sounding reference signal resource indicator power control identifiers.

Some examples of the method, apparatus, and non-transitory computer-readable medium described herein may further include operations, features, means, or instructions for receiving, via the control message, an indication of a default aggregation factor value, the one or more aggregation factor values including the default aggregation factor value, and the default aggregation factor value corresponding to one or more sounding reference signal resource indicators that may be not associated with any of the one or more identifiers.

A method for wireless communication by a network entity is described. The method may include outputting a control message that indicates one or more aggregation factor values, outputting information indicative of a parameter associated with a directional communication between a UE and the network entity, the parameter corresponding to an aggregation factor value of the one or more aggregation factor values, and communicating with the UE in accordance with the aggregation factor value based on the parameter associated with the directional communication.

An apparatus for wireless communication at a network entity is described. The network entity may include one or more memories and one or more processors coupled with the one or more memories. The one or more processors may be configured to cause the network entity to output a control message that indicates one or more aggregation factor values, output information indicative of a parameter associated with a directional communication between a UE and the network entity, the parameter corresponding to an aggregation factor value of the one or more aggregation factor values, and communicate with the UE in accordance with the aggregation factor value based on the parameter associated with the directional communication.

Another apparatus for wireless communication at a network entity is described. The network entity may include means for outputting a control message that indicates one or more aggregation factor values, means for outputting information indicative of a parameter associated with a directional communication between a UE and the network entity, the parameter corresponding to an aggregation factor value of the one or more aggregation factor values, and means for communicating with the UE in accordance with the aggregation factor value based on the parameter associated with the directional communication.

A non-transitory computer-readable medium storing code for wireless communication is described. The code may include instructions executable by one or more processors to cause a network entity to output a control message that indicates one or more aggregation factor values, output information indicative of a parameter associated with a directional communication between a UE and the network entity, the parameter corresponding to an aggregation factor value of the one or more aggregation factor values, and communicate with the UE in accordance with the aggregation factor value based on the parameter associated with the directional communication.

Some examples of the method, apparatus, and non-transitory computer-readable medium described herein may further include operations, features, means, or instructions for outputting, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

In some examples of the method, apparatus, and non-transitory computer-readable medium described herein, each identifier of the one or more identifiers corresponds to a respective transmission configuration indication state identifier of a set of multiple transmission configuration indication state identifiers.

In some examples of the method, apparatus, and non-transitory computer-readable medium described herein, each identifier of the one or more identifiers corresponds to a respective set of transmission configuration indication state identifiers of a set of multiple transmission configuration indication state identifiers that includes the transmission configuration indication state identifier.

Some examples of the method, apparatus, and non-transitory computer-readable medium described herein may further include operations, features, means, or instructions for outputting, via the control message, an indication of a default aggregation factor value, the one or more aggregation factor values including the default aggregation factor value, and the default aggregation factor value corresponding to one or more second transmission configuration indication state identifiers that may be not associated with any of the one or more identifiers.

Some examples of the method, apparatus, and non-transitory computer-readable medium described herein may further include operations, features, means, or instructions for outputting, via the control message, a transmission configuration indication state element, the transmission configuration indication state element including a field that indicates the aggregation factor value, the parameter associated with a transmission configuration indication state provided by the transmission configuration indication state element.

Some examples of the method, apparatus, and non-transitory computer-readable medium described herein may further include operations, features, means, or instructions for outputting, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Some examples of the method, apparatus, and non-transitory computer-readable medium described herein may further include operations, features, means, or instructions for outputting, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Some examples of the method, apparatus, and non-transitory computer-readable medium described herein may further include operations, features, means, or instructions for outputting, via the control message, an indication of an activation of one or more transmission configuration indication states, the parameter associated with a transmission configuration indication state of the one or more transmission configuration indication states.

In some examples of the method, apparatus, and non-transitory computer-readable medium described herein, the control message includes an activation MAC-CE.

Some examples of the method, apparatus, and non-transitory computer-readable medium described herein may further include operations, features, means, or instructions for outputting, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

In some examples of the method, apparatus, and non-transitory computer-readable medium described herein, each identifier of the one or more identifiers corresponds to a respective sounding reference signal resource indicator identifier of a set of multiple sounding reference signal resource indicator identifiers.

In some examples of the method, apparatus, and non-transitory computer-readable medium described herein, each identifier of the one or more identifiers corresponds to a respective sounding reference signal resource indicator power control identifier of a set of multiple sounding reference signal resource indicator power control identifiers.

Some examples of the method, apparatus, and non-transitory computer-readable medium described herein may further include operations, features, means, or instructions for outputting, via the control message, an indication of a default aggregation factor value, the one or more aggregation factor values including the default aggregation factor value, and the default aggregation factor value corresponding to one or more sounding reference signal resource indicators that are not associated with any of the one or more identifiers.

### BRIEF DESCRIPTION OF THE DRAWINGS

FIG. 1 shows an example of a wireless communications system that supports aggregation factor adaptation for directional communication in accordance with one or more aspects of the present disclosure.

FIG. 2 shows an example of a network architecture that supports aggregation factor adaptation for directional communication in accordance with one or more aspects of the present disclosure.

FIG. 3 shows an example of a wireless communications system that supports aggregation factor adaptation for directional communication in accordance with one or more aspects of the present disclosure.

FIG. 4 shows an example of a wireless communications system that supports aggregation factor adaptation for directional communication in accordance with one or more aspects of the present disclosure.

FIG. 5 shows an example of a process flow that supports aggregation factor adaptation for directional communication in accordance with one or more aspects of the present disclosure.

FIGS. 6 and 7 show block diagrams of devices that support aggregation factor adaptation for directional communication in accordance with one or more aspects of the present disclosure.

FIG. 8 shows a block diagram of a communications manager that supports aggregation factor adaptation for directional communication in accordance with one or more aspects of the present disclosure.

FIG. 9 shows a diagram of a system including a device that supports aggregation factor adaptation for directional communication in accordance with one or more aspects of the present disclosure.

FIGS. 10 and 11 show block diagrams of devices that support aggregation factor adaptation for directional communication in accordance with one or more aspects of the present disclosure.

FIG. 12 shows a block diagram of a communications manager that supports aggregation factor adaptation for directional communication in accordance with one or more aspects of the present disclosure.

FIG. 13 shows a diagram of a system including a device that supports aggregation factor adaptation for directional communication in accordance with one or more aspects of the present disclosure.

FIGS. 14 through 19 show flowcharts illustrating methods that support aggregation factor adaptation for directional communication in accordance with one or more aspects of the present disclosure.

### DETAILED DESCRIPTION

Some wireless communications systems may utilize aggregation techniques (e.g., slot aggregation) to improve communication reliability. Some aggregation techniques may include performing a quantity of repetitions for a transmission (e.g., either by a network entity or by a UE) within consecutive time intervals (e.g., consecutive slots). The quantity of repetitions may be based on an aggregation factor value. As described herein “aggregation factor value” may refer to a value that indicates a quantity of repetitions to be performed for a given communication, and may be configured (e.g., indicated, conveyed, or otherwise provided) via control signaling from a network entity. In some cases, the repeated transmissions may increase a likelihood that a given communication is successful and may increase coverage in a wireless communications system. Additionally, in some cases, a UE and a network entity may support directional communications (e.g., shaped or steered communication beams), and may communicate via or otherwise in accordance with various directional communication configurations (e.g., various spatial beam directions, wide beams, narrow beams, via multiple transmission configuration indication (TCI) states).

In some cases, an aggregation factor value may be a same value regardless of a directional communication configuration. That is, a network entity and a UE may perform a same quantity of repeated communications for all directional communication configurations (e.g., for all beams, for all TCI states). However, different directional communication configurations may be associated with different channel qualities (e.g., some directions may be associated with relatively higher or relatively lower interference than other directions). For instance, some directions may be associated with relatively high interference (e.g., may include various obstacles or blockages or other channel interference) and may have a relatively lower channel quality as compared to other directions. Correspondingly, some directions may be associated with relatively low interference (e.g., may be clear of blockages and channel interference) and may have a relatively higher channel quality as compared to other directions. Thus, some quantities of transmission repetitions (e.g., quantities indicated by aggregation factor values) may be relatively less effective (e.g., impactful, significant) in terms of improving communication reliability for directional communications associated with relatively higher channel quality and/or relatively low interference. That is, for some directions, transmitting relatively fewer repetitions may be sufficient, and the additional repetitions may result in redundant (e.g., excessive) utilization of communication resources. Accordingly, utilizing a same aggregation factor value across all directional communication configurations may be relatively inefficient and may increase energy consumption in a wireless communications system due to increased power associated with excessive repetition of communications for some communication directions.

In accordance with one or more aspects of the present disclosure, a network entity and a UE may exchange signaling to configure (e.g., indicate, convey, provide, use, employ, etc.) an aggregation factor value based on a directional communication configuration. For example, the UE may receive one or more control messages that indicate one or more aggregation factor values. Such a control message may be any message that indicates, conveys, provides, or carries control information including, for example, one or more Radio Resource Control (RRC) messages, one or more medium access control (MAC)-control element (MAC-CE) messages, one or more downlink control information (DCI) messages, or any combination thereof. An aggregation factor value may be any information that indicates a quantity of repetitions for a given communication (e.g., a given message or channel). The UE may also receive information that is indicative of a parameter associated with a directional communication between the UE and the network entity. The parameter may be any information that is used to associate a directional communication configuration to an aggregation factor value. In some examples, the parameter may be a TCI state identifier (ID), a TCI state list, a TCI activation message, an ID associated with a sounding reference signal (SRS) resource indicator (SRI) (e.g., an SRI ID, an SRI power control ID), or other information associated with a directional communication. A directional communication may refer to a communication (e.g., a message, a channel) that is shaped or steered (e.g., via an antenna beam) along a spatial path.

In some examples, a UE may receive one or more aggregation factor values that are each associated with a respective ID. The ID may associate a respective aggregation factor value to the parameter (e.g., TCI states, SRIs, SRI power control IDs). Additionally, or alternatively, control signaling for a directional communication configuration (e.g., a TCI state list, a TCI state activation message) may include a corresponding aggregation factor value for the directional communication configuration. For instance, each directional communication configuration (or an activation signal of the directional communication configuration) may indicate an aggregation factor value for the directional communication configuration. In some examples, the UE may utilize a default aggregation factor value based on a TCI state not being associated with an aggregation factor values (e.g., or TCI state element does not include a field indicative of an aggregation factor value). Accordingly, the UE and the network entity may support multiple aggregation factor values for various directional communication configurations.

By applying one or more techniques described herein, a wireless communications system may increase energy savings, reduce communication traffic, increase communication reliability, and support higher network efficiency. For example, a network entity may reduce transmission repetitions in some directions while maintaining (e.g., or increasing) transmission repetitions in other directions, thus enabling increased energy savings without reducing coverage or reliability. Further, by enabling a network entity to configure aggregation factor values per communication direction, a network entity and a UE may reduce signaling traffic, which may reduce system interference and/or provide additional time-frequency resources for other wireless communication devices or other communication types. Moreover, by supporting various aggregation factor values, a UE may perform communications with reduced message repetitions, thus enabling increased battery life, higher data rates, and improved latency.

Additionally, by utilizing respective identifiers for each aggregation factor value that are associated with one or more directional communication parameters, the described techniques may enable a UE to selectively perform communications for multiple directions. Moreover, by enabling a TCI state element, or activation of a TCI state element, to include a field indicating an aggregation factor value, the described techniques may enable a UE to utilize different aggregation factor values for different directional communications without significant increased signaling overhead and more dynamically (e.g., with lower latency as compared to, for example, an RRC reconfiguration of an aggregation factor value, which may be insufficient to adapt to potentially rapidly changing channel qualities or directional communication configurations). Further, by associating an aggregation factor value with an SRI, the described techniques may enable a UE to reduce a quantity of repeated uplink transmissions, thus resulting in improved energy savings and improved battery life.

Aspects of the disclosure are initially described in the context of wireless communications systems. Aspects of the disclosure are further illustrated by and described with reference to process flows, apparatus diagrams, system diagrams, and flowcharts that relate to aggregation factor adaptation for directional communication.

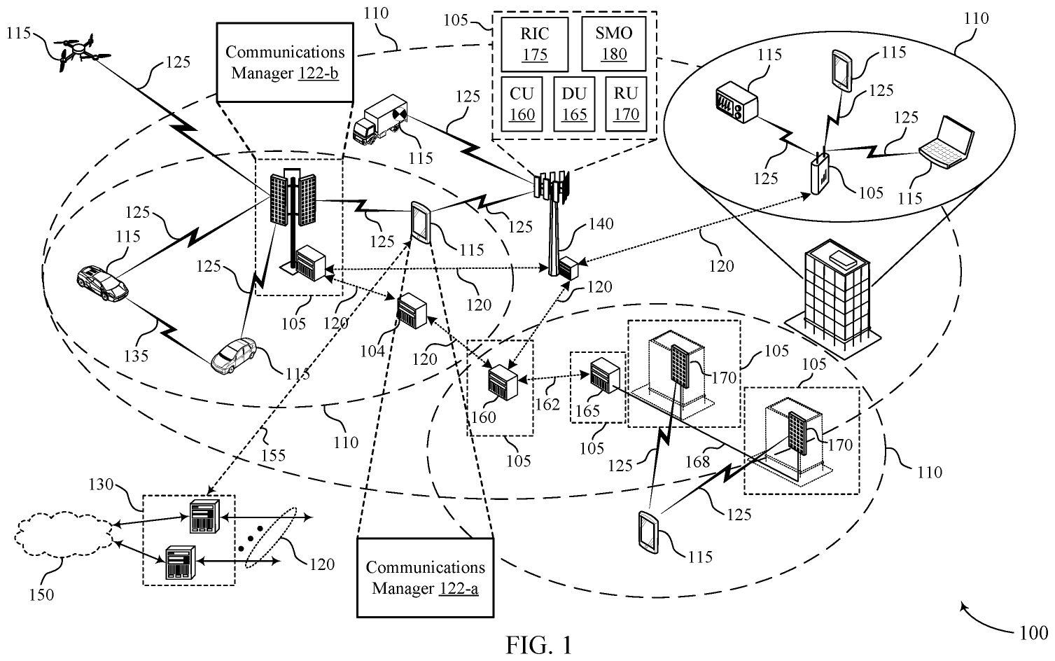

FIG. 1 shows an example of a wireless communications system 100 that supports aggregation factor adaptation for directional communication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support aggregation factor adaptation for directional communication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology)

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, be misaligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some cases, the wireless communications system 100 may utilize aggregation techniques to improve communication reliability. For example, a network entity 105 or a UE 115 may repeat a transmission within consecutive slots to increase a likelihood that the transmission is successfully received. A quantity of repetitions may be based on an aggregation factor value, which may be configured via one or more control messages. Additionally, a UE 115 and a network entity 105 may support directional communications, and may communicate via various directional communication configurations (e.g., spatial beams directions, wide beams, narrow beams, via multiple TCI states). In some cases, an aggregation factor value may be uniform for all directional communications (e.g., for all beams, for all TCI states). However, different directional communication configurations may be associated with different channel qualities (e.g., some directions may be associated with relatively higher or relatively lower interference), and relatively high aggregation factor values may be less beneficial for some directional communications (e.g., low interference directions). Accordingly, utilizing a same aggregation factor value across all directional communication configurations may increase energy consumption in the wireless communications system 100.

In accordance with one or more aspects of the present disclosure, a UE 115 may include a communications manager 122-a and a network entity 105 may include a communications manager 122-b which may enable to the respective devices to perform one or more techniques described herein. In some examples, a network entity 105, via or in accordance with the communications manager 122-b, may configure an aggregation factor value based on a directional communication configuration (e.g., may configure an aggregation factor value per direction). For example, the UE 115, via or in accordance with the communications manager 122-a, may receive one or more control messages from the network entity 105 that indicate one or more aggregation factor values and may also receive information that is indicative of a parameter associated with a directional communication between the UE 115 and the network entity 105. The parameter may associate a directional communication configuration to an aggregation factor value. For example, an aggregation factor value may be assigned an ID and the parameter may be associated with one or more TCI state IDs or with one or more IDs of an SRI. The one or more control messages may indicate an association between the aggregation factor value ID and one or more TCI state IDs and the one or more SRIs. Accordingly, the UE 115, via or in accordance with the communications manager 122-1, and the network entity 105, via or in accordance with the communications manager 122-b, may support multiple aggregation factor values for various directional communication configurations, which increase energy savings and improve network efficiency in the wireless communications system 100.

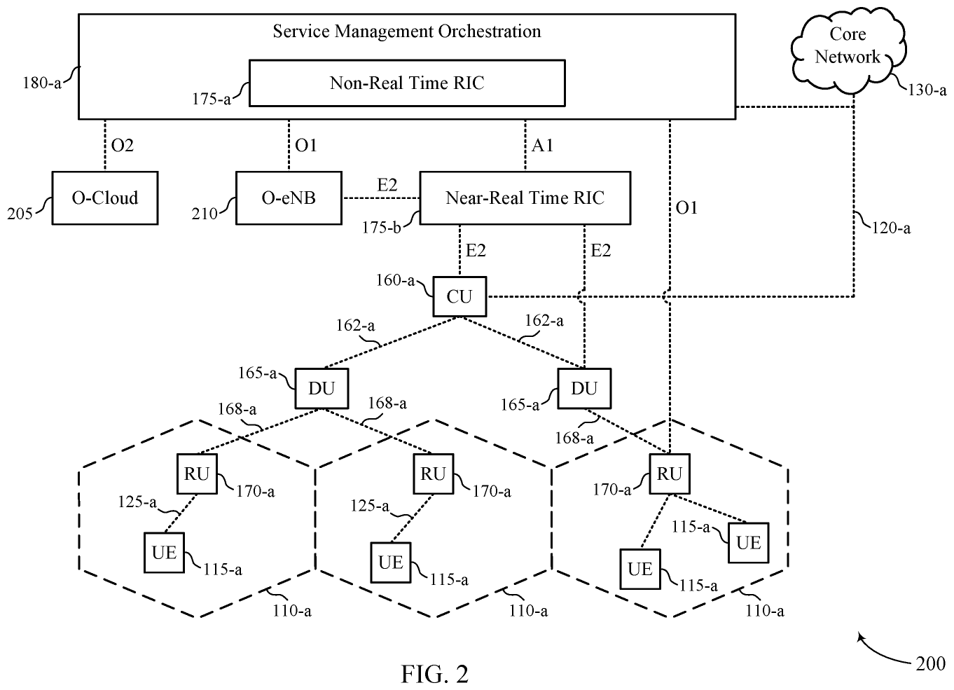

FIG. 2 shows an example of a network architecture 200 (e.g., a disaggregated base station architecture, a disaggregated RAN architecture) that supports aggregation factor adaptation for directional communication in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., Al policies).

In some cases, the network architecture 200 may support repeated transmissions within consecutive slots according to an aggregation factor value to improve communication reliability. Additionally, the network architecture 200 may support directional communications, which may enable a device to shape and/or steer transmissions to other devices. In some cases, an aggregation factor value may be uniform for all directional communications, which may result in excess utilization of communication resources. In accordance with aspects of the present disclosure, the devices of the network architecture 200 (e.g., a network entity 105, a CU 160, a DU 165, an SMO 180, a core network 130) may configure an aggregation factor value based on a communication direction. For example, a UE 115 may receive information that is indicative of a parameter associated with a directional communication. The parameter may associate one or more directional communication configurations to an aggregation factor value. Accordingly, the network architecture 200 may support multiple aggregation factor values for various directional communication configurations, which may increase energy savings and improve network efficiency.

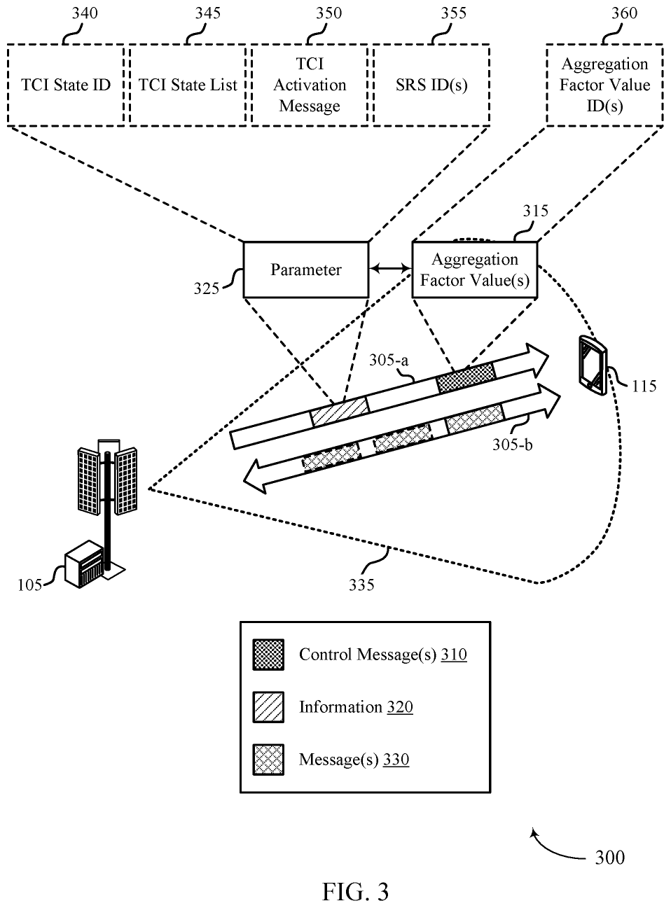

FIG. 3 shows an example of a wireless communications system 300 that supports aggregation factor adaptation for directional communication in accordance with one or more aspects of the present disclosure. The wireless communications system 300 may implement or be implemented by aspects of the wireless communications system 100 or the network architecture 200 as described with reference to FIGS. 1 and 2. For example, the wireless communications system 300 may include a network entity 105 and a UE 115, which may be examples of or include network entities 105, UEs 115, CUs 160, DUs 165, RUs 170, network nodes, or other devices as described with reference to FIGS. 1 and 2.

The network entity 105 may communicate with the UE 115 via a communication link 305-a and a communication link 305-b. The communication links 305 may be examples of or include downlink communication interfaces, uplink communication interfaces, or other communication interfaces. In some examples, the network entity 105 may communicate (e.g., transmit) one or more control messages 310 and information 320 to the UE 115 via the communication link 305-a. The network entity 105 and the UE 115 may communicate (e.g., transmit and/or receive) one or more messages 330 via a communication link 305-b based on the one or more control messages 310 and the information 320. The wireless communications system 300 may support configuration of an aggregation factor value 315 based on a parameter 325 corresponding to a directional communication configuration 335.

In some cases, the wireless communications system 300 may support one or more techniques for network energy savings. For example, the wireless communications system 300 may support dynamic adaptation of a spatial domain and a power domain, cell discontinuous operations (e.g., cell discontinuous transmission (DTX) or discontinuous reception (DRX)), which may enable a network entity 105 to support relatively longer sleep durations. In some cases, the wireless communications system 300 may further save energy if a network entity 105 reduces some signaling (e.g., redundant signaling). However, some regulations may prohibit a network entity 105 from freely configuring some signaling parameters for the purpose of network energy savings, such as aggregation factor values.

The wireless communications system 300 may support slot aggregation techniques to increase reliability of communications. Slot aggregation may be defined for multiple communication types and may refer to a parameter (e.g., an RRC parameter, an aggregation factor value) that determines a quantity of repetitions in consecutive slots (e.g., consecutive time resources) for a given transmission (e.g., of a message 330). As described herein, the quantity of repetitions for a given message 330 may be referred to as an aggregation factor value or a repetition factor. An aggregation factor value 315 may be any value (e.g., 1, 2, 4, 8, or other integer value), and the network entity 105 may transmit one or more control messages 310 to the UE 115 that include one or more aggregation factor values 315. In some cases, the one or more aggregation factor values 315 may be configured per UE 115.

An aggregation factor value 315 may be configured for several types of communication (e.g., for various RRC information elements of a control message 310) such as in physical downlink shared channel (PDSCH) configurations (e.g., PDSCH-Config), physical uplink shared channel (PUSCH) configurations (e.g., PUSCH-Config), semi-persistent scheduling (SPS) configurations (e.g., SPS-Config), and broadcast configurations (PDSCH-ConfigBroadcast), among other examples. For example, a PDSCH configuration may include an aggregation factor value 315 (e.g., a pdsch-AggregationFactor field), which may define a quantity of repetitions for a PDSCH message. Additionally, or alternatively, an SPS configuration may include an aggregation factor value 315, which may define a quantity of repetitions for SPS PDSCH. Additionally, or alternatively, a broadcast configuration may include an aggregation factor value 315, which may define a quantity of repetitions for dynamic scheduling of multicast and broadcast service (MBS) data. Additionally, or alternatively, a PUSCH configuration may include an aggregation factor value 315 (e.g., a pusch-AggregationFactor field), which may define a quantity of repetitions for a PUSCH message. If an aggregation factor value 315 is absent from a configuration (e.g., the configuration does not include an aggregation factor value 315), the UE 115 may apply a default value (e.g., 1) as the aggregation factor value 315 or may apply an aggregation factor value 315 from a different configuration (e.g., from a PDSCH-Config).

As a non-limiting example, the UE 115 may receive a message from the network entity 105 (e.g., a DCI message) that schedules a message 330 (e.g., a PDSCH transmission) to be received by the UE 115. The network entity 105 may repeat the message 330 a quantity of (e.g., a quantity “n”) times in consecutive slots, and the quantity (e.g., the aggregation factor value, the repetition factor) may be given by an RRC configuration parameter (e.g., by a pdsch-AggregationFactor, by a field of an RRC information element). That is, the network entity 105 may transmit (e.g., the UE 115 may expect to receive) the message 330 and one or more repetitions of the message 330 based on an aggregation factor value 315. In some cases, the repetition factor may increase the coverage associated with the wireless communications system 300 (e.g., via a combining of multiple instances of the message 330 at the UE 115 or via increasing a likelihood that at least one instance of the message 330 propagates over-the-air with a sufficiently small amount of interference, or both).

However, in some cases, an aggregation factor value 315 may be defined per configuration (e.g., per RRC configuration) and may lack a definition per directional communication configuration 335 (e.g., may lack a definition per direction via which the network entity provides network coverage). For instance, the network entity 105 and the UE 115 may be configured to communicate via one or more directional communication configurations 335 (e.g., one or multiple beam directions, one or multiple wide beams, one or multiple narrow beams, one or multiple TCI states, one or multiple SRI configurations). Some directional communication configurations 335 may include communications via one or more reconfigurable intelligent surfaces (RISs), which also may be referred to as reflective intelligent surfaces. In some cases, an aggregation factor value 315 may be configured to be a same value irrespective of a directional communication configuration 335 (e.g., regardless of a transmission direction, a same quantity of repetitions in all directions). Such cases may lead to an imbalance (e.g., of resource utilization) and an increased quantity (e.g., a wasteful quantity) of configured repetitions. Accordingly, a network entity 105 (e.g., and a UE 115) may support increased energy savings if a quantity of repetitions of a message 330 are reduced (e.g., for at least some directional communication configurations 335).

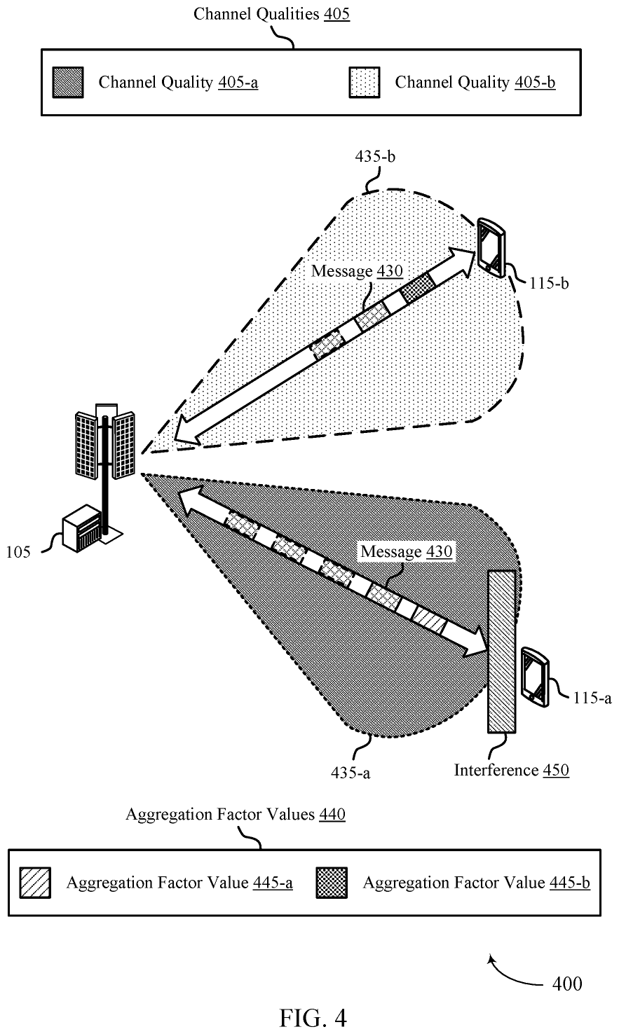

In accordance with aspects of the present disclosure, the wireless communications system 300 may support techniques to configure (e.g., define, set, indicate) an aggregation factor value 315 based on a directional communication configuration 335 (e.g., per direction). As described herein, directional communication configuration 335 may refer to (e.g., may be defined in terms of) one or more TCI states, spatial relation information, or one or more SRI indications, or any combination thereof. In some examples, the UE 115 may receive one or more control messages 310 that may include (e.g., define, set, indicate) a set of aggregation factor values 315 (e.g., pdsch-AggregationFactor values). Each value of the set of aggregation factor values 315 may be a pair of an aggregation value and an aggregation factor ID 360 (or some other ID). The UE 115 may also receive the information 320, which may be indicative of a parameter 325 that is associated with the directional communication configuration 335 (e.g., as described in greater detail herein, including with reference to FIG. 4). In some examples, the information 320 may be received separate from the one or more control messages 310, may be included in the one or more control messages 310, or both. The parameter 325 may be a TCI state ID 340, a TCI state list 345, a TCI state activation message 350, one or more SRS IDs 355 (e.g., an SRI ID, or an ID associated with an SRI power control), other information associated with a directional communication configuration 335, or any combination thereof and may correspond to an aggregation factor value 315 (e.g., to an aggregation factor ID 360).

Accordingly, the network entity 105 and the UE 115 may communicate (e.g., transmit and/or receive) one or more messages 330 in accordance with an aggregation factor value 315 that is configured (e.g., determined, indicated, set, selected) based on the parameter 325 that is associated with the directional communication configuration 335. Such communications may reduce (in relatively low interference scenarios) a quantity of repetitions associated with various messages 330 between the network entity 105 and the UE 115. As a result, the wireless communications system 300 may be enabled to support increased energy savings, improved spectral efficiency, and increased network capacity. Alternatively, such communications may efficiently increase the quantity of repetitions associated with various messages 330 between the network entity 105 and the UE 115 in relatively high interference scenarios, such as by selectively (e.g., conditionally) increasing the quantity of repetitions if the directional communication configuration 335 is associated with relatively high interference (e.g., because of a blockage).

FIG. 4 shows an example of a wireless communications system 400 that supports aggregation factor adaptation for directional communication in accordance with one or more aspects of the present disclosure. The wireless communications system 400 may implement or be implemented by aspects of the wireless communications system 100, the network architecture 200, and the wireless communications system 300. For example, the wireless communications system 400 may include a network entity 105, a UE 115-a, and a UE 115-b, which may be examples respective devices as described with reference to FIGS. 1 through 3. The network entity 105 may communicate with multiple UEs 115 via multiple directional communication configurations 435 (e.g., TCI states, shaped beams, steered beams, transmission directions, spatially diverse communications). Although the example of FIG. 4 shows a first directional communication configuration 435-a and a second directional communication configuration 435-b (e.g., with a UE 115-a and a UE 115-b respectively), a wireless communications system 400 may include any quantity of directional communication configurations 435 with any quantity of UEs 115.

In some cases, a coverage area of the network entity 105 may include multiple directional communication configurations 435 (e.g., multiple sectors). In a first directional communication configuration 435-a, a channel quality 405-a may be relatively low. In a second directional communication configuration 435-b, a channel quality 405-b may be relatively high. The difference between channel qualities 405 may be based on a difference in channel conditions such as interference 450 (e.g., due to obstacles, blockages, and/or other RF energy), loading conditions, among other conditions. For example, the first directional communication configuration 435-a may be associated with interference 450 (e.g., blockages and/or obstructions) and the second directional communication configuration 435-b may not be associated with interference 450 (e.g., or the first directional communication configuration 435-a may include relatively higher interference as compared to the second directional communication configuration 435-b).

To improve communication quality associated with the first directional communication configuration 435-a, the network entity 105 may configure a relatively high quantity of repetitions of a message 430 (e.g., a relatively high aggregation factor) in the first directional communication configuration 435-a (e.g., in the sector experiencing high interference). However, in some systems, a network entity 105 may support a same quantity of repetitions for all directional communication configurations 435, which may impact the transmissions of a message 430 in other directions (e.g., to a same UE 115, to different UEs 115). For instance, a first quantity of repetitions may significantly improve communications (e.g., in terms of facilitating successful communication) in the first directional communication configuration 435-a but may be less significant (e.g., may provide a smaller impact in terms of facilitating successful communication) in the second directional communication configuration 435-b. Thus, the wireless communications system 400 may reduce energy consumption at the network entity 105 and the UEs 115 by reducing the quantity of repetitions (e.g., repetitions that are associated with a relatively high channel quality).

In accordance with techniques described herein, an aggregation factor value 440 may be configured for each directional communication configuration 435 (e.g., based on a parameter associated with a directional communication configuration 435). For example, the UE 115-a may receive (e.g., identify) a first aggregation factor value 445-a based on a first control message (e.g., a control message 310) and first information (e.g., information 320) from the network entity 105, and the UE 115-b may receive (e.g., identify) a second aggregation factor value 445-b based on a second control message (e.g., a control message 310) and second information (e.g., information 320) from the network entity 105. The first control message and the first information may associate the first aggregation factor value 445-a (e.g., four) to the first directional communication configuration 435-a, and the second control message and the second information may associate a second aggregation factor value 445-b (e.g., two) to the second directional communication configuration 435-b. In some aspects, the first control message and the second control message may be a same control message, but may refer to different portions of (e.g., different parameters, elements or aggregation factor values 440 carried by) the same control message.

In some examples, the aggregation factor value 440 may be associated with downlink communications. A set of aggregation factor values 440 (e.g., multiple pdsch-AggregationFactor values) may be defined (e.g., configured, indicated, signaled). The set of aggregation factor values 440 (e.g., a list of values) may defined such that each value in the set may be a pair of an aggregation factor value 440 and an ID. In some implementations, the set of aggregation factor values 440 may include (e.g., define) a default value. The default value may be explicitly configured or may be associated with a specific ID (e.g., a default value ID). In a first example, a UE 115 may use an aggregation factor value 440 with an ID that is equal to a TCI state ID (e.g., a parameter 325, each TCI state ID may correspond to a respective aggregation factor value ID via, for example, a one-to-one correspondence). Such an example may be depicted by Table 1. The values of Table 1 may be non-limiting examples, and it is to be understood that the values may be any value, including values different than the values shown. If there is no aggregation factor value 440 in the list that has an ID that is equal to a configured TCI state ID (e.g., a TCI state ID in a grant), the UE 115 may select (e.g., pick, ascertain, determine, choose) a default aggregation factor value 440 (e.g., one).

TABLE 1

| Aggregation Factor Value | Identifier | TCI State ID |
|---|---|---|
| 2 | 1 | 1 |
| 4 | 2 | 2 |
| 8 | 3 | 3 |

In a second example, a UE 115 may use an aggregation factor value 440 with an ID that corresponds to multiple TCI state IDs (e.g., an ID that is smaller than or equal to a TCI state ID, a many-to-one correspondence). Such cases may accommodate multiple TCI state values (e.g., in cases of multiple TCI states configured at a UE 115). Such an example may be depicted by Table 2. The values of Table 2 may be non-limiting examples, and it is to be understood that the values may any value including values different than the values shown. Further, although ranges of consecutive TCI state IDs are shown as corresponding to a respective aggregation factor value, a non-consecutive (e.g., in terms of numeric ID or index) set of TCI state IDs may be grouped and correspond to a respective aggregation factor value.

TABLE 2

| Aggregation Factor Value | Identifier | TCI State ID |
|---|---|---|
| 2 | 10 | 1-10 |
| 4 | 20 | 11-20 |
| 8 | 30 | 21-30 |

For example, the first directional communication configuration 435-a may be associated with a first TCI state ID and the second directional communication configuration 435-b may be associated with a second TCI state ID. In accordance with an ID associated with an aggregation factor value 440 in the set, a UE 115 may select a corresponding aggregation factor value 440 based on whether the UE communicates with the network entity 105 via the first directional communication configuration 435-a or the second directional communication configuration 435-b (e.g., using a TCI state ID to aggregation value ID correspondence).

Additionally, or alternatively, a new field may be added to a TCI state element (e.g., a parameter 325, an element of a tci-StatesToAddModList, an element of a tci-StatesToReleaseList) that includes an aggregation factor value 440. In such examples, a UE 115 may be indicated (e.g., receive a TCI state element) to be scheduled with a downlink message (e.g., a PDSCH message) with given TCI state. Accordingly, the UE 115 may assume (e.g., select, determine, identify) the aggregation factor value 440 given by the TCI state element. If an aggregation factor value field is absent (e.g., missing) from a TCI state element (e.g., TCI state definition, if the TCI state element does not include the aggregation factor value field), the UE 115 may assume a default quantity of repetitions (e.g., one) to be the aggregation factor value 440 or a same value as another configuration (e.g., as configured by a pdsch-AggregationFactor in PDSCH-Config). For example, a UE 115 may receive information (e.g., information 320) for a directional communication configuration 435, and the information may include an aggregation factor value.

Additionally, or alternatively, a control message (e.g., a MAC-CE) may indicate an activation of a given TCI state (e.g., a parameter 325). The activation control message may carry an indication of a respective aggregation factor value 440 for some or all of the activated TCI states. For example, a UE 115 may be scheduled for a downlink message (e.g., a PDSCH message) with a given TCI state, and the UE may use an aggregation factor value 440 that is indicated in the activation control message (e.g., in the MAC-CE, which may be understood as an activation MAC-CE). If the aggregation factor value 440 is absent from (e.g., not included in) the activation control message, the UE 115 may assume the aggregation factor value 440 to be a same value as indicated in another configuration (e.g., as a pdsch-AggregationFactor of another RRC information element) or a default value (e.g., one).

In some examples, the aggregation factor value 440 may be associated with uplink communications. In such examples, a set of (e.g., list of) aggregation factor values 440 (e.g., multiple pusch-AggregationFactor values) may defined (e.g., configured, indicated, signaled) such that each element (e.g., entry) in the set is associated with an ID. Each aggregation factor ID may be associated with an SRI ID (e.g., a parameter 325, an SRI ID as potentially indicated in a DCI message that schedules a PUSCH message). Additionally, or alternatively, the aggregation factor ID may be included in a SRI power control configuration (e.g., a parameter 325, SRI-PUSCH-PowerControl). A UE 115 may transmit an uplink message (e.g., a message 430) with a quantity of repetitions that is indicated by the aggregation factor value 440 (e.g., the pusch-AggregationFactor) that is associated with the SRI in accordance with the SRI ID, an ID included with the SRI power control configuration, or both. An aggregation factor value 440 (of the set of aggregation factor values) may be defined to be a default value that may be used by a UE 115 in case an indicated SRI power control is not associated with or does not correspond to an aggregation factor ID.

An aggregation factor ID may be included in (e.g., or otherwise associated with) a field associated with an uplink configuration (e.g., a PUSCH-Config, a pusch-PowerControl, an sri-PUSCH-MappingToAddModList). For example, an uplink configuration (e.g., a PUSCH-Config RRC information element) may include a field associated with a list of SRIs (e.g., an sri-PUSCH-MappingToAddModList) that includes one or more SRI power control configurations, which may also be associated with a respective ID (e.g., SRI-PUSCH-PowerControl (Id, PLreferenceRS-Id, alphasetId, ClosedLoopIndex)). The respective ID (e.g., SRI ID, SRI power control ID) may be associated with other fields of the uplink configuration (e.g., the ID may serve as a reference pointer for other fields). For example, the respective ID may be associated with one or more fields of a pusch-PowerControl such as a p0-NominalWithoutGrant, a p0-PUSCH-SetList (e.g., including a list of P0-PUSCH-Set (id, list of P0)), a pathlossReferenceRSToAddModListr (e.g., including a list of PUSCH-PathlossReferenceRS (Id, referencesignal)), an Olpc-ParameterSet (e.g., including olpc-ParameterSetDCI-0-1 INTEGER (1 . . . 2)), or any combination thereof. Additionally, or alternatively, the respective ID may be associated with one or more fields of a pusch-PowerControl such as a p0-NominalWithoutGrant, a p0-AlphaSets (e.g., including a list of P0-PUSCH-AlphaSet (id, P0, alpha)), a pathlossReferenceRSToAddModList (e.g., including a list of PUSCH-PathlossReferenceRS (Id, referencesignal)), or any combination thereof. In such examples, a PUSCH-Configcommon may include a field, p0-NominalWithGrant. A list of P0 may be one or two values. An enableDefaultBeamPL-ForSRS may be a cell level configuration. A mapping between an sri-PUSCH-PowerControl ID and a PUSCH-PathlossReferenceRS-Id may be updated by a control message (e.g., a MAC-CE). Accordingly, an aggregation factor ID may be associated with various SRI-related IDs as described.

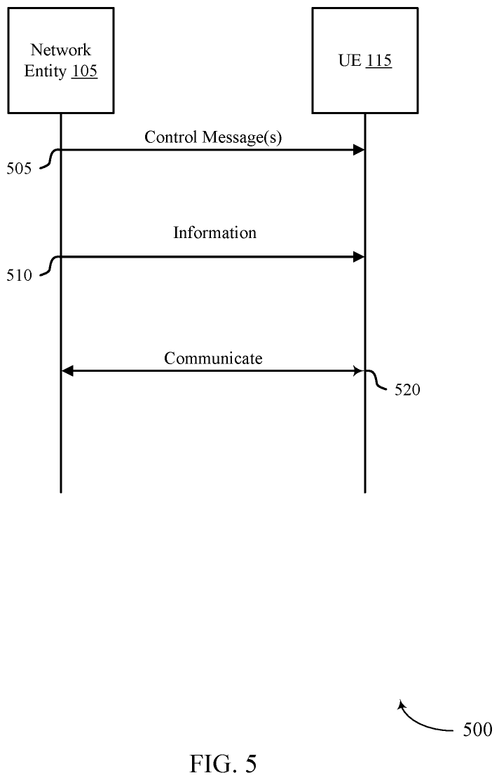

FIG. 5 shows an example of a process flow 500 that supports aggregation factor adaptation for directional communication in accordance with one or more aspects of the present disclosure. In some examples, the process flow 500 may implement aspects of the wireless communications system 100, the network architecture 200, the wireless communications system 300, and the wireless communications system 400. For example, the process flow 500 may support signaling between a UE 115 and a network entity 105 to enable configuration of aggregation factor values (e.g., aggregation factor value 315) based on a direction of communication (e.g., a directional communication configuration 335). The UE 115 and the network entity 105 of the process flow 500 may be examples of corresponding devices herein, including with reference to FIGS. 1 through 4.

In the following description of process flow 500, the operations between the UE 115 and the network entity 105 may be performed in a different order than the order shown, or other operations may be added or removed from the process flow 500. For example, some operations may also be left out of process flow 500, or may be performed in different orders or at different times. Further, although some operations or signaling may be shown to occur at different times for discussion purposes, these operations may actually occur at the same time. Although the UE 115 and the network entity 105 are shown performing the operations of process flow 500, some aspects of some operations may also be performed by one or more other wireless or network devices.

At 505, the UE 115 may the UE 115 may receive (e.g., the network entity 105 may output) one or more control messages (e.g., one or more control messages 310, RRC messages, MAC-CE messages, DCI messages) that indicate one or more aggregation factor values (e.g., aggregation factor values 315). In some examples, the UE 115 may also receive, via the control message, one or more IDs associated with the one or more aggregation factor values (e.g., aggregation factor IDs). Each respective ID of the one or more IDs may be associated with a respective aggregation factor value of the one or more aggregation factor values. In some examples, each respective ID of the one or more IDs may correspond to a respective TCI state ID of a set of multiple of TCI state IDs. Additionally, or alternatively, each respective ID of the one or more IDs may correspond to a respective set of TCI state IDs (e.g., a subset of TCI state IDs) of multiple of TCI state IDs (e.g., that includes a TCI state ID corresponding to an aggregation factor ID). In some examples, the UE 115 may receive, via the control message, an indication of a default aggregation factor value, and the one or more aggregation factor values may include the default aggregation factor value. The default aggregation factor value may correspond to one or more second TCI state IDs that are not associated with (e.g., that lack an association with) any of the one or more IDs.

In some examples, the UE 115 may receive, via the control message, a TCI state element (e.g., an element of a tci-StatesToAddModList, an element in a sequence of TCI states). The TCI state element may include a field that indicates the aggregation factor value. Additionally, or alternatively, the UE 115 may receive, via the control message, a set of multiple of TCI state elements, and each respective TCI state element of the set of multiple of TCI state elements may include a respective field that indicates a respective aggregation factor value. In some examples, the UE 115 may receive, via the control message, a TCI state element that does not include (e.g., lacks) a field that indicates the aggregation factor value. In such examples, the aggregation factor value (e.g., associated with the TCI state element lacking the field) may correspond to a default aggregation factor value based on the TCI state element not including (e.g., lacking) the field (e.g., based on the TCI state not including the field, based on an absence of the field from the TCI state element). Additionally, or alternatively, the UE 115 may receive, via the control message, an indication of an activation of one or more TCI states (e.g., an activation MAC-CE, a message that activates one or more TCI states). In some examples, the control message may include an activation MAC-CE.

In some examples, the UE 115 may receive, via the control message, one or more IDs associated with the one or more aggregation factor values, and each respective ID of the one or more IDs may be associated with a respective aggregation factor value of the one or more aggregation factor values. Each respective ID of the one or more IDs may correspond to a respective SRI ID of a set of multiple of SRI IDs. Additionally, or alternatively, each respective ID of the one or more IDs may correspond to a respective SRI power control ID (e.g., an SRI-PUSCH-PowerControl ID, or an aggregation factor ID included in a SRI-PUSCH-PowerControl configuration) of a set of multiple of SRI power control IDs. In some examples, the UE 115 may receive, via the control message, an indication of a default aggregation factor value. The one or more aggregation factor values may include the default aggregation factor value. The default aggregation factor value may correspond to one or more SRIs that are not associated with (e.g., that lack an association with) any of the one or more IDs

At 510, the UE 115 may receive information indicative of a parameter associated with a directional communication between the UE 115 and the network entity 105. The parameter may correspond to an aggregation factor value of the one or more aggregation factor values. For example, the parameter may be associated with a TCI state ID that corresponds to an ID of the one or more IDs (e.g., aggregation factor IDs). Additionally, or alternatively, the parameter may be associated with a TCI state provided by a TCI state element of a set of multiple of TCI state elements. Additionally, or alternatively, the parameter may be associated with an activation of a TCI state of one or more TCI states that are activated via a control message. Additionally, or alternatively, the parameter may be associated with a SRI that corresponds to an ID of the one or more IDs. In some examples, the information indicative of the parameter may be, additionally, or alternatively, received via the one or more control messages (e.g., at 505).

At 520, the UE 115 and the network entity 105 may communicate in accordance with the aggregation factor value based on the parameter associated with the directional communication. For example, the parameter (e.g., a TCI state ID, a TCI state element, an activation message of a TCI state, an SRI ID, an SRI power control ID) may associate an aggregation factor value (e.g., a quantity of message repetitions) to a directional communication (e.g., a directional communication configuration 335, a spatial direction, a shaped beam direction, a steered beam direction). Accordingly, different messages associated with different directional communications may be transmitted in accordance with different aggregation factor values based on techniques described herein. Such techniques may enable a UE 115 and a network entity 105 to increase energy savings and provide more efficient utilization of communication resources.

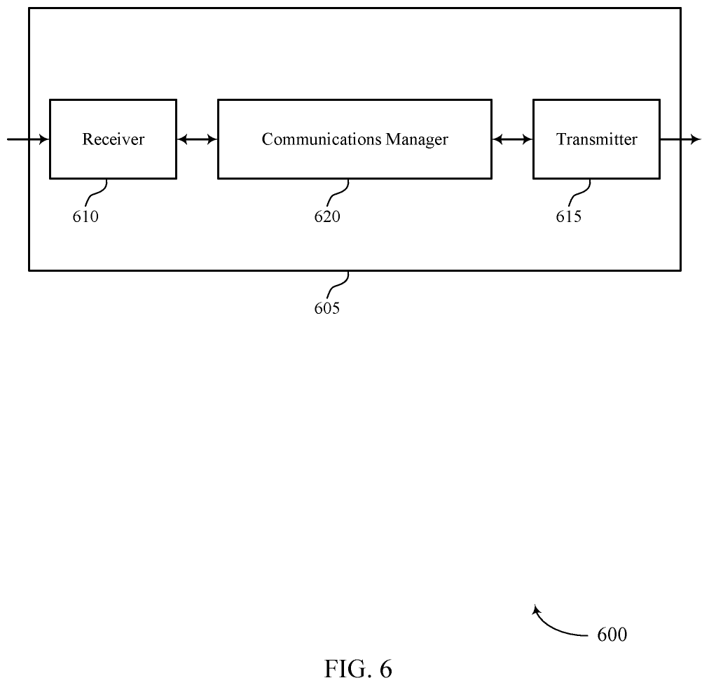

FIG. 6 shows a block diagram 600 of a device 605 that supports aggregation factor adaptation for directional communication in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to aggregation factor adaptation for directional communication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to aggregation factor adaptation for directional communication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of aggregation factor adaptation for directional communication as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, determining, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving a control message that indicates one or more aggregation factor values. The communications manager 620 is capable of, configured to, or operable to support a means for receiving information indicative of a parameter associated with a directional communication between the UE and a network entity, the parameter corresponding to an aggregation factor value of the one or more aggregation factor values. The communications manager 620 is capable of, configured to, or operable to support a means for communicating with the network entity in accordance with the aggregation factor value based on the parameter associated with the directional communication.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

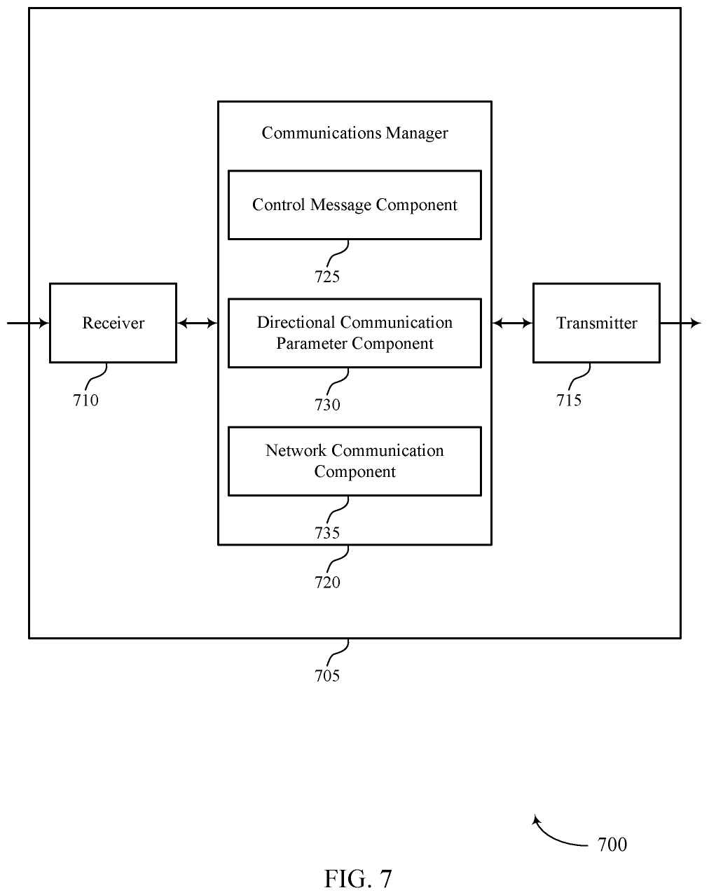

FIG. 7 shows a block diagram 700 of a device 705 that supports aggregation factor adaptation for directional communication in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to aggregation factor adaptation for directional communication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to aggregation factor adaptation for directional communication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of aggregation factor adaptation for directional communication as described herein. For example, the communications manager 720 may include a control message component 725, a directional communication parameter component 730, a network communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The control message component 725 is capable of, configured to, or operable to support a means for receiving a control message that indicates one or more aggregation factor values. The directional communication parameter component 730 is capable of, configured to, or operable to support a means for receiving information indicative of a parameter associated with a directional communication between the UE and a network entity, the parameter corresponding to an aggregation factor value of the one or more aggregation factor values. The network communication component 735 is capable of, configured to, or operable to support a means for communicating with the network entity in accordance with the aggregation factor value based on the parameter associated with the directional communication.

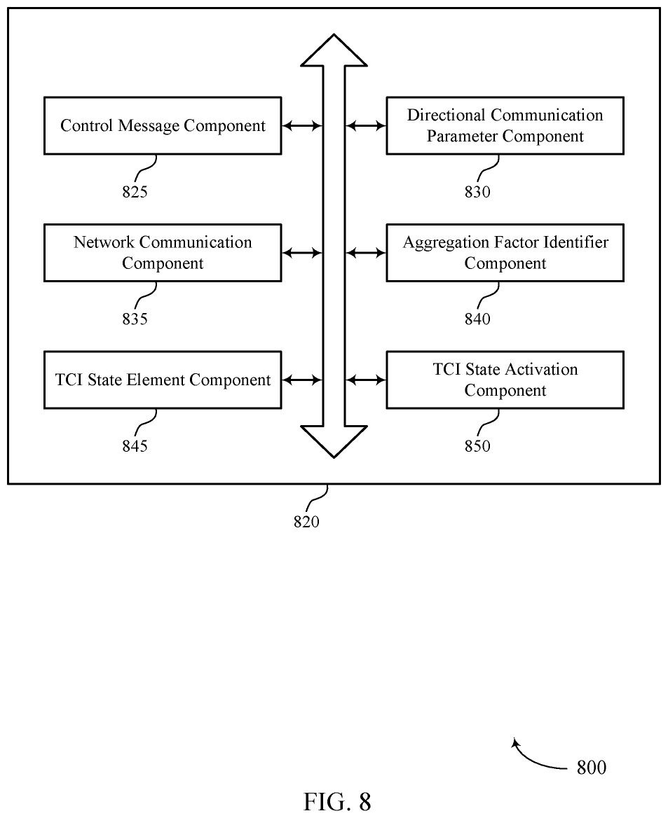

FIG. 8 shows a block diagram 800 of a communications manager 820 that supports aggregation factor adaptation for directional communication in accordance with one or more aspects of the present disclosure. The communications manager 820 may be an example of aspects of a communications manager 620, a communications manager 720, or both, as described herein. The communications manager 820, or various components thereof, may be an example of means for performing various aspects of aggregation factor adaptation for directional communication as described herein. For example, the communications manager 820 may include a control message component 825, a directional communication parameter component 830, a network communication component 835, an aggregation factor identifier component 840, a TCI state element component 845, a TCI state activation component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The control message component 825 is capable of, configured to, or operable to support a means for receiving a control message that indicates one or more aggregation factor values. The directional communication parameter component 830 is capable of, configured to, or operable to support a means for receiving information indicative of a parameter associated with a directional communication between the UE and a network entity, the parameter corresponding to an aggregation factor value of the one or more aggregation factor values. The network communication component 835 is capable of, configured to, or operable to support a means for communicating with the network entity in accordance with the aggregation factor value based on the parameter associated with the directional communication.

In some examples, the aggregation factor identifier component 840 is capable of, configured to, or operable to support a means for receiving, via the control message, one or more identifiers associated with the one or more aggregation factor values, each identifier of the one or more identifiers associated with a respective aggregation factor value of the one or more aggregation factor values, and the parameter associated with a TCI state identifier that corresponds to an identifier of the one or more identifiers.

In some examples, each identifier of the one or more identifiers corresponds to a respective TCI state identifier of a set of multiple TCI state identifiers.

In some examples, each identifier of the one or more identifiers corresponds to a respective set of TCI state identifiers of a set of multiple TCI state identifiers that includes the TCI state identifier.

In some examples, the aggregation factor identifier component 840 is capable of, configured to, or operable to support a means for receiving, via the control message, an indication of a default aggregation factor value, the one or more aggregation factor values including the default aggregation factor value, and the default aggregation factor value corresponding to one or more second TCI state identifiers that are not associated with any of the one or more identifiers.

In some examples, the TCI state element component 845 is capable of, configured to, or operable to support a means for receiving, via the control message, a TCI state element, the TCI state element including a field that indicates the aggregation factor value, the parameter associated with a TCI state provided by the TCI state element.

In some examples, the TCI state element component 845 is capable of, configured to, or operable to support a means for receiving, via the control message, a set of multiple TCI state elements, each TCI state element of the set of multiple TCI state elements including a field that indicates a respective aggregation factor value, the parameter associated with a TCI state provided by a TCI state element of the set of multiple TCI state elements.

In some examples, the TCI state element component 845 is capable of, configured to, or operable to support a means for receiving, via the control message, a TCI state element, the TCI state element not including (e.g., lacking) a field that indicates the aggregation factor value, the parameter associated with a TCI state provided by the TCI state element, and the aggregation factor value corresponding to a default aggregation factor value based on the TCI state element not including the field (e.g., based on an absence of the field from the TCI state element).

In some examples, the TCI state activation component 850 is capable of, configured to, or operable to support a means for receiving, via the control message, an indication of an activation of one or more TCI states, the parameter associated with a TCI state of the one or more TCI states.

In some examples, the control message includes an activation medium access control (MAC)-control element (MAC-CE).

In some examples, the aggregation factor identifier component 840 is capable of, configured to, or operable to support a means for receiving, via the control message, one or more identifiers associated with the one or more aggregation factor values, each identifier of the one or more identifiers associated with a respective aggregation factor value of the one or more aggregation factor values, and the parameter associated with a SRI that corresponds to an identifier of the one or more identifiers.

In some examples, each identifier of the one or more identifiers corresponds to a respective SRI identifier of a set of multiple SRI identifiers.

In some examples, each identifier of the one or more identifiers corresponds to a respective SRI power control identifier of a set of multiple SRI power control identifiers.

In some examples, the aggregation factor identifier component 840 is capable of, configured to, or operable to support a means for receiving, via the control message, an indication of a default aggregation factor value, the one or more aggregation factor values including the default aggregation factor value, and the default aggregation factor value corresponding to one or more SRIs that are not associated with any of the one or more identifiers.

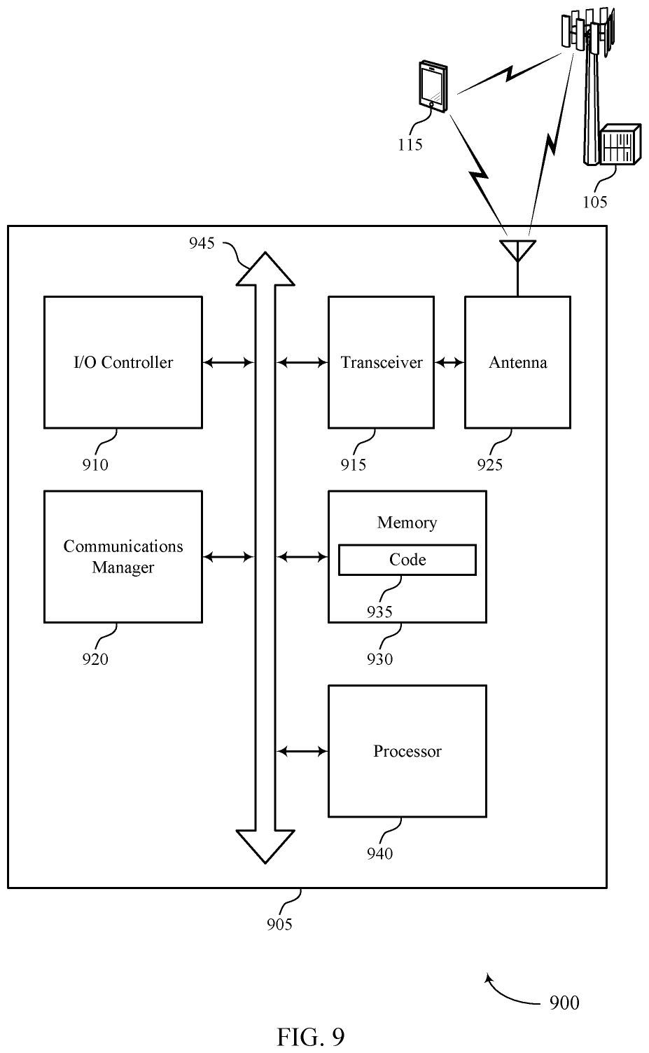

FIG. 9 shows a diagram of a system 900 including a device 905 that supports aggregation factor adaptation for directional communication in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting aggregation factor adaptation for directional communication). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving a control message that indicates one or more aggregation factor values. The communications manager 920 is capable of, configured to, or operable to support a means for receiving information indicative of a parameter associated with a directional communication between the UE and a network entity, the parameter corresponding to an aggregation factor value of the one or more aggregation factor values. The communications manager 920 is capable of, configured to, or operable to support a means for communicating with the network entity in accordance with the aggregation factor value based on the parameter associated with the directional communication.

By including or configuring the communications manager 920 in accordance with examples as described herein, the device 905 may support techniques for reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of aggregation factor adaptation for directional communication as described herein, or the at least one processor 940 and the at least one memory 930 may be otherwise configured to, individually or collectively, perform or support such operations.

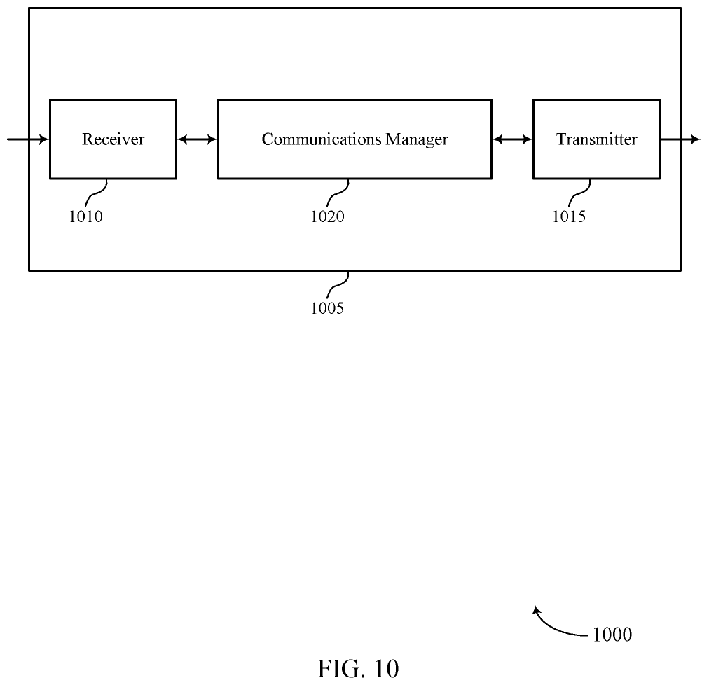

FIG. 10 shows a block diagram 1000 of a device 1005 that supports aggregation factor adaptation for directional communication in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of aggregation factor adaptation for directional communication as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. For example, the communications manager 1020 is capable of, configured to, or operable to support a means for outputting a control message that indicates one or more aggregation factor values. The communications manager 1020 is capable of, configured to, or operable to support a means for outputting information indicative of a parameter associated with a directional communication between a UE and the network entity, the parameter corresponding to an aggregation factor value of the one or more aggregation factor values. The communications manager 1020 is capable of, configured to, or operable to support a means for communicating with the UE in accordance with the aggregation factor value based on the parameter associated with the directional communication.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

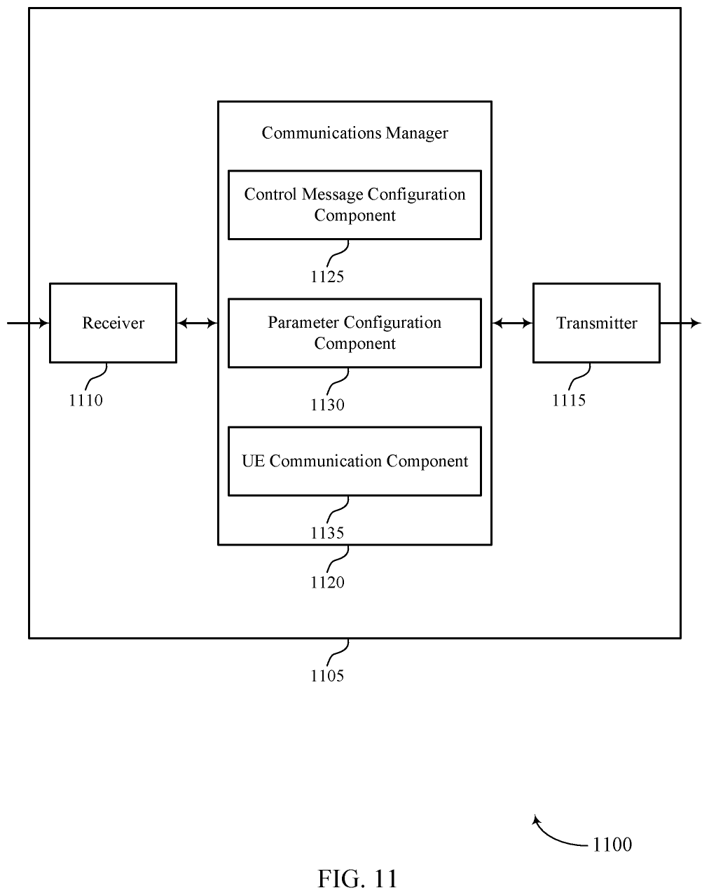

FIG. 11 shows a block diagram 1100 of a device 1105 that supports aggregation factor adaptation for directional communication in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of aggregation factor adaptation for directional communication as described herein. For example, the communications manager 1120 may include a control message configuration component 1125, a parameter configuration component 1130, a UE communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. The control message configuration component 1125 is capable of, configured to, or operable to support a means for outputting a control message that indicates one or more aggregation factor values. The parameter configuration component 1130 is capable of, configured to, or operable to support a means for outputting information indicative of a parameter associated with a directional communication between a UE and the network entity, the parameter corresponding to an aggregation factor value of the one or more aggregation factor values. The UE communication component 1135 is capable of, configured to, or operable to support a means for communicating with the UE in accordance with the aggregation factor value based on the parameter associated with the directional communication.

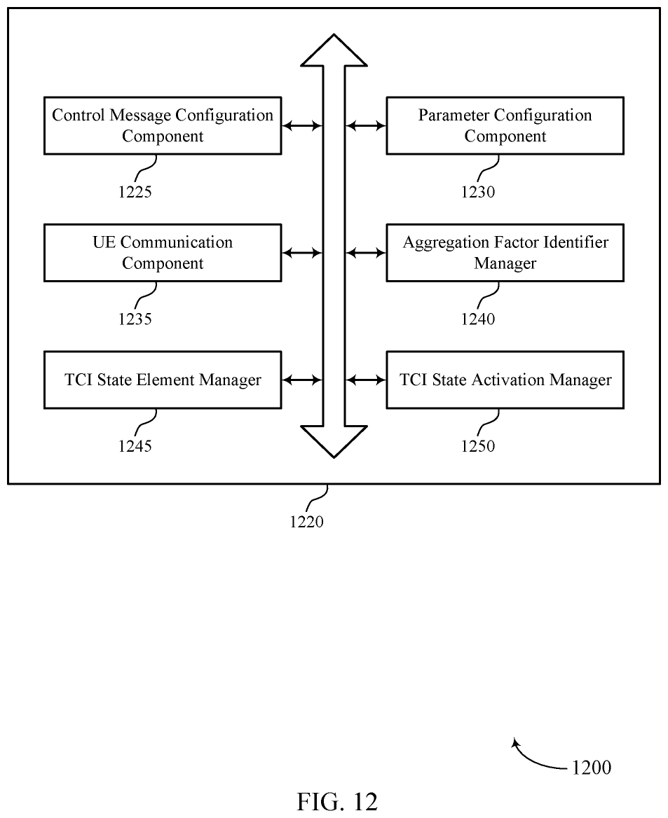

FIG. 12 shows a block diagram 1200 of a communications manager 1220 that supports aggregation factor adaptation for directional communication in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of aggregation factor adaptation for directional communication as described herein. For example, the communications manager 1220 may include a control message configuration component 1225, a parameter configuration component 1230, a UE communication component 1235, an aggregation factor identifier manager 1240, a TCI state element manager 1245, a TCI state activation manager 1250, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication in accordance with examples as disclosed herein. The control message configuration component 1225 is capable of, configured to, or operable to support a means for outputting a control message that indicates one or more aggregation factor values. The parameter configuration component 1230 is capable of, configured to, or operable to support a means for outputting information indicative of a parameter associated with a directional communication between a UE and the network entity, the parameter corresponding to an aggregation factor value of the one or more aggregation factor values. The UE communication component 1235 is capable of, configured to, or operable to support a means for communicating with the UE in accordance with the aggregation factor value based on the parameter associated with the directional communication.

In some examples, the aggregation factor identifier manager 1240 is capable of, configured to, or operable to support a means for outputting, via the control message, one or more identifiers associated with the one or more aggregation factor values, each identifier of the one or more identifiers associated with a respective aggregation factor value of the one or more aggregation factor values, and the parameter associated with a TCI state identifier that corresponds to an identifier of the one or more identifiers.

In some examples, each identifier of the one or more identifiers corresponds to a respective TCI state identifier of a set of multiple TCI state identifiers.

In some examples, each identifier of the one or more identifiers corresponds to a respective set of TCI state identifiers of a set of multiple TCI state identifiers that includes the TCI state identifier.

In some examples, the aggregation factor identifier manager 1240 is capable of, configured to, or operable to support a means for outputting, via the control message, an indication of a default aggregation factor value, the one or more aggregation factor values including the default aggregation factor value, and the default aggregation factor value corresponding to one or more second TCI state identifiers that are not associated with any of the one or more identifiers.

In some examples, the TCI state element manager 1245 is capable of, configured to, or operable to support a means for outputting, via the control message, a TCI state element, the TCI state element including a field that indicates the aggregation factor value, the parameter associated with a TCI state provided by the TCI state element.

In some examples, the TCI state element manager 1245 is capable of, configured to, or operable to support a means for outputting, via the control message, a set of multiple TCI state elements, each TCI state element of the set of multiple TCI state elements including a field that indicates a respective aggregation factor value, the parameter associated with a TCI state provided by a TCI state element of the set of multiple TCI state elements.

In some examples, the TCI state element manager 1245 is capable of, configured to, or operable to support a means for outputting, via the control message, a TCI state element, the TCI state element not including (e.g., lacking) a field that indicates the aggregation factor value, the parameter associated with a TCI state provided by the TCI state element, and the aggregation factor value corresponding to a default aggregation factor value based on the TCI state element not including the field (e.g., based on an absence of the field from the TCI state element).

In some examples, the TCI state activation manager 1250 is capable of, configured to, or operable to support a means for outputting, via the control message, an indication of an activation of one or more TCI states, the parameter associated with a TCI state of the one or more TCI states.

In some examples, the control message includes an activation medium access control (MAC)-control element (MAC-CE).

In some examples, the aggregation factor identifier manager 1240 is capable of, configured to, or operable to support a means for outputting, via the control message, one or more identifiers associated with the one or more aggregation factor values, each identifier of the one or more identifiers associated with a respective aggregation factor value of the one or more aggregation factor values, and the parameter associated with a SRI that corresponds to an identifier of the one or more identifiers.

In some examples, each identifier of the one or more identifiers corresponds to a respective SRI identifier of a set of multiple SRI identifiers.

In some examples, each identifier of the one or more identifiers corresponds to a respective SRI power control identifier of a set of multiple SRI power control identifiers.

In some examples, the aggregation factor identifier manager 1240 is capable of, configured to, or operable to support a means for outputting, via the control message, an indication of a default aggregation factor value, the one or more aggregation factor values including the default aggregation factor value, and the default aggregation factor value corresponding to one or more SRIs that are not associated with any of the one or more identifiers.

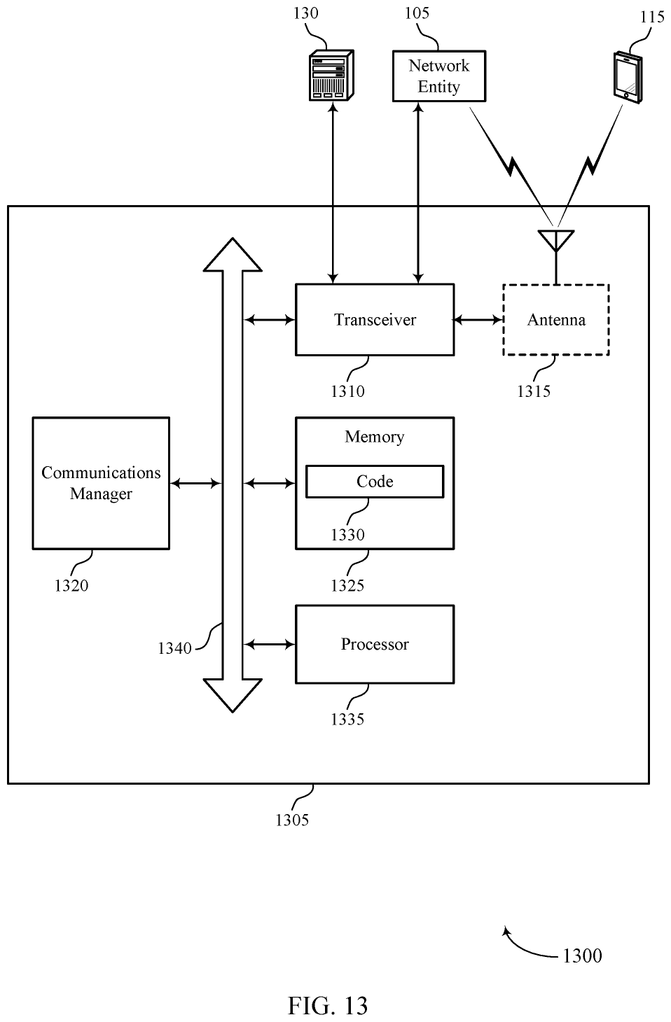

FIG. 13 shows a diagram of a system 1300 including a device 1305 that supports aggregation factor adaptation for directional communication in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting aggregation factor adaptation for directional communication). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication in accordance with examples as disclosed herein. For example, the communications manager 1320 is capable of, configured to, or operable to support a means for outputting a control message that indicates one or more aggregation factor values. The communications manager 1320 is capable of, configured to, or operable to support a means for outputting information indicative of a parameter associated with a directional communication between a UE and the network entity, the parameter corresponding to an aggregation factor value of the one or more aggregation factor values. The communications manager 1320 is capable of, configured to, or operable to support a means for communicating with the UE in accordance with the aggregation factor value based on the parameter associated with the directional communication.

By including or configuring the communications manager 1320 in accordance with examples as described herein, the device 1305 may support techniques for reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of aggregation factor adaptation for directional communication as described herein, or the at least one processor 1335 and the at least one memory 1325 may be otherwise configured to, individually or collectively, perform or support such operations.

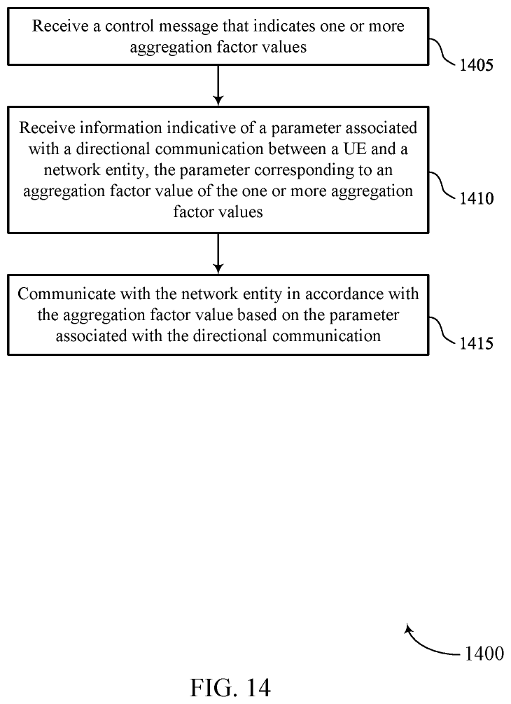

FIG. 14 shows a flowchart illustrating a method 1400 that supports aggregation factor adaptation for directional communication in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message that indicates one or more aggregation factor values. The operations of block 1405 may be performed in accordance with examples as disclosed herein. In some examples, aspects of the operations of 1405 may be performed by a control message component 825 as described with reference to FIG. 8.

At 1410, the method may include receiving information indicative of a parameter associated with a directional communication between the UE and a network entity, the parameter corresponding to an aggregation factor value of the one or more aggregation factor values. The operations of block 1410 may be performed in accordance with examples as disclosed herein. In some examples, aspects of the operations of 1410 may be performed by a directional communication parameter component 830 as described with reference to FIG. 8.

At 1415, the method may include communicating with the network entity in accordance with the aggregation factor value based on the parameter associated with the directional communication. The operations of block 1415 may be performed in accordance with examples as disclosed herein. In some examples, aspects of the operations of 1415 may be performed by a network communication component 835 as described with reference to FIG. 8.

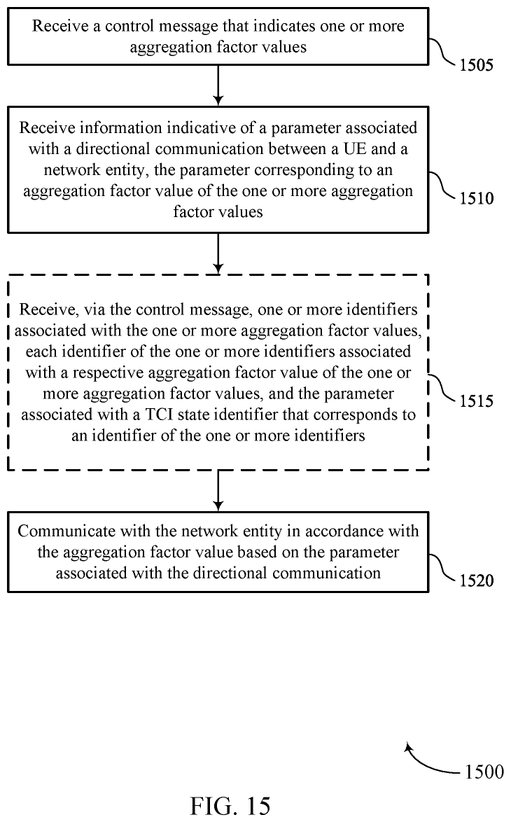

FIG. 15 shows a flowchart illustrating a method 1500 that supports aggregation factor adaptation for directional communication in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message that indicates one or more aggregation factor values. The operations of block 1505 may be performed in accordance with examples as disclosed herein. In some examples, aspects of the operations of 1505 may be performed by a control message component 825 as described with reference to FIG. 8.

At 1510, the method may include receiving information indicative of a parameter associated with a directional communication between the UE and a network entity, the parameter corresponding to an aggregation factor value of the one or more aggregation factor values. The operations of block 1510 may be performed in accordance with examples as disclosed herein. In some examples, aspects of the operations of 1510 may be performed by a directional communication parameter component 830 as described with reference to FIG. 8.

At 1515, the method may include receiving, via the control message, one or more identifiers associated with the one or more aggregation factor values, each identifier of the one or more identifiers associated with a respective aggregation factor value of the one or more aggregation factor values, and the parameter associated with a TCI state identifier that corresponds to an identifier of the one or more identifiers. The operations of block 1515 may be performed in accordance with examples as disclosed herein. In some examples, aspects of the operations of 1515 may be performed by an aggregation factor identifier component 840 as described with reference to FIG. 8.

At 1520, the method may include communicating with the network entity in accordance with the aggregation factor value based on the parameter associated with the directional communication. The operations of block 1520 may be performed in accordance with examples as disclosed herein. In some examples, aspects of the operations of 1520 may be performed by a network communication component 835 as described with reference to FIG. 8.

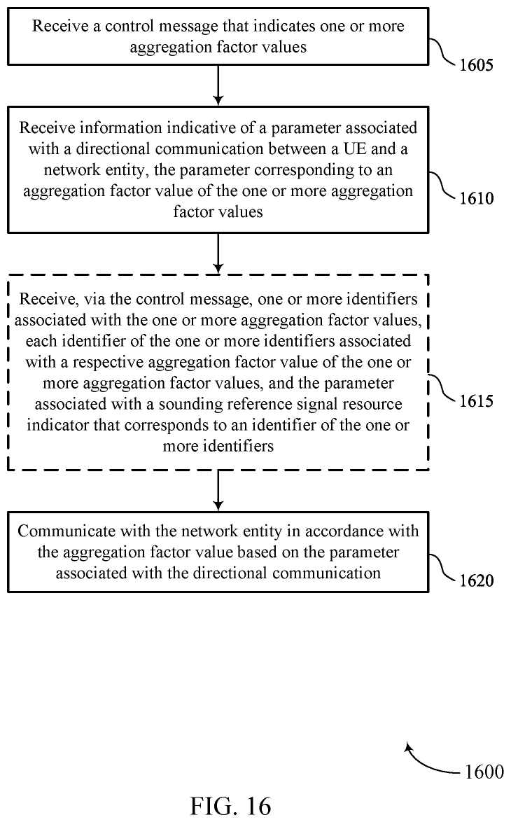

FIG. 16 shows a flowchart illustrating a method 1600 that supports aggregation factor adaptation for directional communication in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message that indicates one or more aggregation factor values. The operations of block 1605 may be performed in accordance with examples as disclosed herein. In some examples, aspects of the operations of 1605 may be performed by a control message component 825 as described with reference to FIG. 8.

At 1610, the method may include receiving information indicative of a parameter associated with a directional communication between the UE and a network entity, the parameter corresponding to an aggregation factor value of the one or more aggregation factor values. The operations of block 1610 may be performed in accordance with examples as disclosed herein. In some examples, aspects of the operations of 1610 may be performed by a directional communication parameter component 830 as described with reference to FIG. 8.

At 1615, the method may include receiving, via the control message, one or more identifiers associated with the one or more aggregation factor values, each identifier of the one or more identifiers associated with a respective aggregation factor value of the one or more aggregation factor values, and the parameter associated with a SRI that corresponds to an identifier of the one or more identifiers. The operations of block 1615 may be performed in accordance with examples as disclosed herein. In some examples, aspects of the operations of 1615 may be performed by an aggregation factor identifier component 840 as described with reference to FIG. 8.

At 1620, the method may include communicating with the network entity in accordance with the aggregation factor value based on the parameter associated with the directional communication. The operations of block 1620 may be performed in accordance with examples as disclosed herein. In some examples, aspects of the operations of 1620 may be performed by a network communication component 835 as described with reference to FIG. 8.

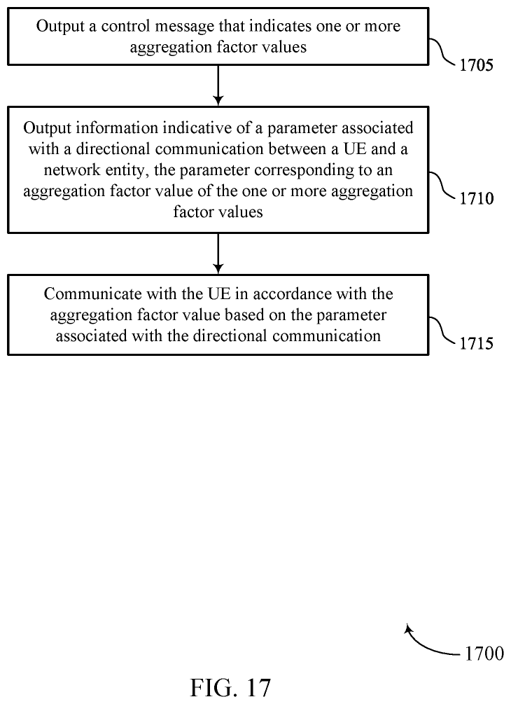

FIG. 17 shows a flowchart illustrating a method 1700 that supports aggregation factor adaptation for directional communication in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a control message that indicates one or more aggregation factor values. The operations of block 1705 may be performed in accordance with examples as disclosed herein. In some examples, aspects of the operations of 1705 may be performed by a control message configuration component 1225 as described with reference to FIG. 12.

At 1710, the method may include outputting information indicative of a parameter associated with a directional communication between a UE and the network entity, the parameter corresponding to an aggregation factor value of the one or more aggregation factor values. The operations of block 1710 may be performed in accordance with examples as disclosed herein. In some examples, aspects of the operations of 1710 may be performed by a parameter configuration component 1230 as described with reference to FIG. 12.

At 1715, the method may include communicating with the UE in accordance with the aggregation factor value based on the parameter associated with the directional communication. The operations of block 1715 may be performed in accordance with examples as disclosed herein. In some examples, aspects of the operations of 1715 may be performed by a UE communication component 1235 as described with reference to FIG. 12.

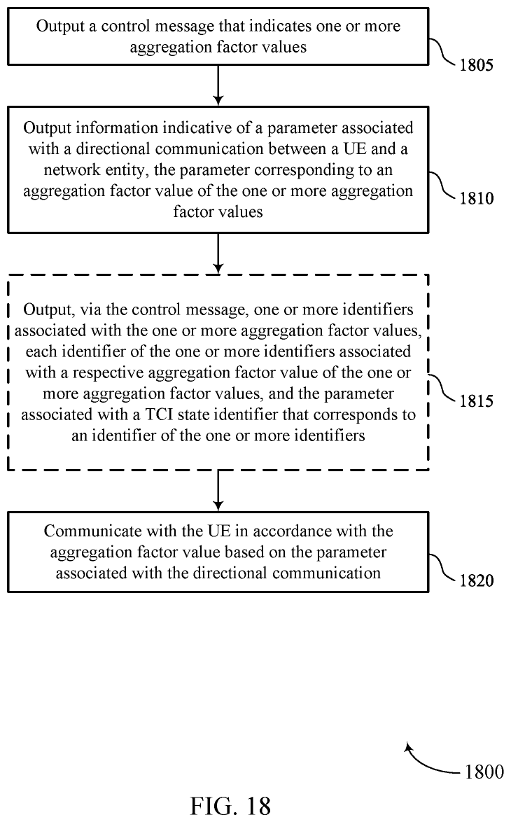

FIG. 18 shows a flowchart illustrating a method 1800 that supports aggregation factor adaptation for directional communication in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control message that indicates one or more aggregation factor values. The operations of block 1805 may be performed in accordance with examples as disclosed herein. In some examples, aspects of the operations of 1805 may be performed by a control message configuration component 1225 as described with reference to FIG. 12.

At 1810, the method may include outputting information indicative of a parameter associated with a directional communication between a UE and the network entity, the parameter corresponding to an aggregation factor value of the one or more aggregation factor values. The operations of block 1810 may be performed in accordance with examples as disclosed herein. In some examples, aspects of the operations of 1810 may be performed by a parameter configuration component 1230 as described with reference to FIG. 12.

At 1815, the method may include outputting, via the control message, one or more identifiers associated with the one or more aggregation factor values, each identifier of the one or more identifiers associated with a respective aggregation factor value of the one or more aggregation factor values, and the parameter associated with a TCI state identifier that corresponds to an identifier of the one or more identifiers. The operations of block 1815 may be performed in accordance with examples as disclosed herein. In some examples, aspects of the operations of 1815 may be performed by an aggregation factor identifier manager 1240 as described with reference to FIG. 12.

At 1820, the method may include communicating with the UE in accordance with the aggregation factor value based on the parameter associated with the directional communication. The operations of block 1820 may be performed in accordance with examples as disclosed herein. In some examples, aspects of the operations of 1820 may be performed by a UE communication component 1235 as described with reference to FIG. 12.

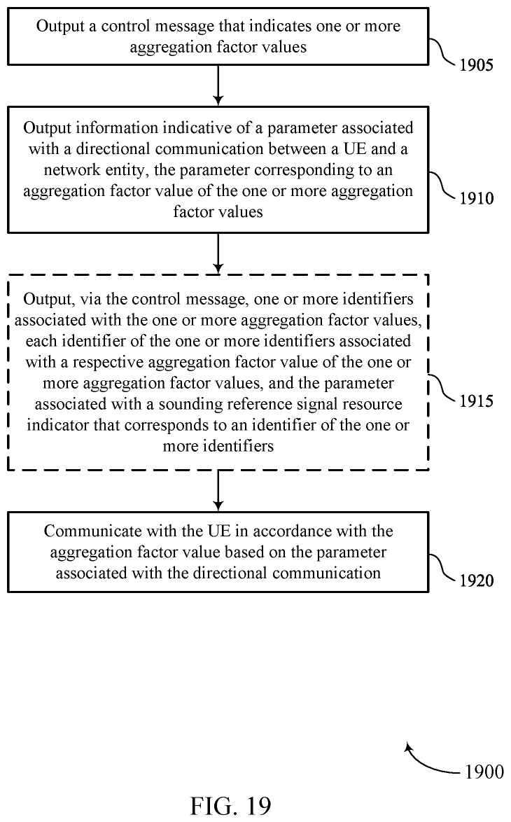

FIG. 19 shows a flowchart illustrating a method 1900 that supports aggregation factor adaptation for directional communication in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include outputting a control message that indicates one or more aggregation factor values. The operations of block 1905 may be performed in accordance with examples as disclosed herein. In some examples, aspects of the operations of 1905 may be performed by a control message configuration component 1225 as described with reference to FIG. 12.

At 1910, the method may include outputting information indicative of a parameter associated with a directional communication between a UE and the network entity, the parameter corresponding to an aggregation factor value of the one or more aggregation factor values. The operations of block 1910 may be performed in accordance with examples as disclosed herein. In some examples, aspects of the operations of 1910 may be performed by a parameter configuration component 1230 as described with reference to FIG. 12.

At 1915, the method may include outputting, via the control message, one or more identifiers associated with the one or more aggregation factor values, each identifier of the one or more identifiers associated with a respective aggregation factor value of the one or more aggregation factor values, and the parameter associated with a SRI that corresponds to an identifier of the one or more identifiers. The operations of block 1915 may be performed in accordance with examples as disclosed herein. In some examples, aspects of the operations of 1915 may be performed by an aggregation factor identifier manager 1240 as described with reference to FIG. 12.

At 1920, the method may include communicating with the UE in accordance with the aggregation factor value based on the parameter associated with the directional communication. The operations of block 1920 may be performed in accordance with examples as disclosed herein. In some examples, aspects of the operations of 1920 may be performed by a UE communication component 1235 as described with reference to FIG. 12.

The following provides an overview of aspects of the present disclosure:

Aspect 1: An apparatus for wireless communication at UE, including: one or more memories; and one or more processors coupled with the one or more memories and configured to cause the UE to: receive a control message that indicates one or more aggregation factor values; receive information indicative of a parameter associated with a directional communication between the UE and a network entity, the parameter corresponding to an aggregation factor value of the one or more aggregation factor values; and communicate with the network entity in accordance with the aggregation factor value based on the parameter associated with the directional communication.

Aspect 2: The apparatus of aspect 1, where the one or more processors are further configured to cause the UE to: receive, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

Aspect 3: The apparatus of aspect 2, where each identifier of the one or more identifiers corresponds to a respective transmission configuration indication state identifier of a set of multiple transmission configuration indication state identifiers.

Aspect 4: The apparatus of any of aspects 2 through 3, where each identifier of the one or more identifiers corresponds to a respective set of transmission configuration indication state identifiers of a set of multiple transmission configuration indication state identifiers that includes the transmission configuration indication state identifier.

Aspect 5: The apparatus of any of aspects 2 through 4, where the one or more processors are further configured to cause the UE to: receive, via the control message, an indication of a default aggregation factor value, the one or more aggregation factor values including the default aggregation factor value, and the default aggregation factor value corresponding to one or more second transmission configuration indication state identifiers that are not associated with any of the one or more identifiers.

Aspect 6: The apparatus of any of aspects 1 through 5, where the one or more processors are further configured to cause the UE to: receive, via the control message, a transmission configuration indication state element, the transmission configuration indication state element including a field that indicates the aggregation factor value, the parameter associated with a transmission configuration indication state provided by the transmission configuration indication state element.

Aspect 7: The apparatus of any of aspects 1 through 6, where the one or more processors are further configured to cause the UE to: receive, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Aspect 8: The apparatus of any of aspects 1 through 7, where the one or more processors are further configured to cause the UE to: receive, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Aspect 9: The apparatus of any of aspects 1 through 8, where the one or more processors are further configured to cause the UE to: receive, via the control message, an indication of an activation of one or more transmission configuration indication states, the parameter associated with a transmission configuration indication state of the one or more transmission configuration indication states.

Aspect 10: The apparatus of aspect 9, where the control message includes an activation MAC-CE.

Aspect 11: The apparatus of aspect 1 through 10, where the one or more processors are further configured to cause the UE to: receive, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

Aspect 12: The apparatus of aspect 11, where each identifier of the one or more identifiers corresponds to a respective sounding reference signal resource indicator identifier of a set of multiple sounding reference signal resource indicator identifiers.

Aspect 13: The apparatus of any of aspects 11 through 12, where each identifier of the one or more identifiers corresponds to a respective sounding reference signal resource indicator power control identifier of a set of multiple sounding reference signal resource indicator power control identifiers.

Aspect 14: The apparatus of any of aspects 11 through 13, where the one or more processors are further configured to cause the UE to: receive, via the control message, an indication of a default aggregation factor value, the one or more aggregation factor values including the default aggregation factor value, and the default aggregation factor value corresponding to one or more sounding reference signal resource indicators that are not associated with any of the one or more identifiers.

Aspect 15: A method for wireless communication at a UE, including: receiving a control message that indicates one or more aggregation factor values; receiving information indicative of a parameter associated with a directional communication between the UE and a network entity, the parameter corresponding to an aggregation factor value of the one or more aggregation factor values; and communicating with the network entity in accordance with the aggregation factor value based on the parameter associated with the directional communication.

Aspect 16: The method of aspect 15, further including: receiving, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

Aspect 17: The method of aspect 16, where each identifier of the one or more identifiers corresponds to a respective transmission configuration indication state identifier of a set of multiple transmission configuration indication state identifiers.

Aspect 18: The method of any of aspects 16 through 17, where each identifier of the one or more identifiers corresponds to a respective set of transmission configuration indication state identifiers of a set of multiple transmission configuration indication state identifiers that includes the transmission configuration indication state identifier.

Aspect 19: The method of any of aspects 16 through 18, further including: receiving, via the control message, an indication of a default aggregation factor value, the one or more aggregation factor values including the default aggregation factor value, and the default aggregation factor value corresponding to one or more second transmission configuration indication state identifiers that are not associated with any of the one or more identifiers.

Aspect 20: The method of any of aspects 15 through 19, further including: receiving, via the control message, a transmission configuration indication state element, the transmission configuration indication state element including a field that indicates the aggregation factor value, the parameter associated with a transmission configuration indication state provided by the transmission configuration indication state element.

Aspect 21: The method of any of aspects 15 through 20, further including: receiving, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Aspect 22: The method of any of aspects 15 through 21, further including: receiving, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Aspect 23: The method of any of aspects 15 through 22, further including: receiving, via the control message, an indication of an activation of one or more transmission configuration indication states, the parameter associated with a transmission configuration indication state of the one or more transmission configuration indication states.

Aspect 24: The method of aspect 23, where the control message includes an activation MAC-CE.

Aspect 25: The method of any of aspects 15 through 24, further including: receiving, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

Aspect 26: The method of aspect 25, where each identifier of the one or more identifiers corresponds to a respective sounding reference signal resource indicator identifier of a set of multiple sounding reference signal resource indicator identifiers.

Aspect 27: The method of any of aspects 25 through 26, where each identifier of the one or more identifiers corresponds to a respective sounding reference signal resource indicator power control identifier of a set of multiple sounding reference signal resource indicator power control identifiers.

Aspect 28: The method of any of aspects 25 through 27, further including: receiving, via the control message, an indication of a default aggregation factor value, the one or more aggregation factor values including the default aggregation factor value, and the default aggregation factor value corresponding to one or more sounding reference signal resource indicators that are not associated with any of the one or more identifiers.

Aspect 29: A network entity, including: one or more memories; and one or more processors coupled with the one or more memories and configured to cause the network entity to: output a control message that indicates one or more aggregation factor values; output information indicative of a parameter associated with a directional communication between a UE and the network entity, the parameter corresponding to an aggregation factor value of the one or more aggregation factor values; and communicate with the UE in accordance with the aggregation factor value based on the parameter associated with the directional communication.

Aspect 30: The network entity of aspect 29, where the one or more processors are further configured to cause the network entity to: output, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

Aspect 31: The network entity of aspect 30, where each identifier of the one or more identifiers corresponds to a respective transmission configuration indication state identifier of a set of multiple transmission configuration indication state identifiers.

Aspect 32: The network entity of any of aspects 30 through 31, where each identifier of the one or more identifiers corresponds to a respective set of transmission configuration indication state identifiers of a set of multiple transmission configuration indication state identifiers that includes the transmission configuration indication state identifier.

Aspect 33: The network entity of any of aspects 30 through 32, where the one or more processors are further configured to cause the network entity to: output, via the control message, an indication of a default aggregation factor value, the one or more aggregation factor values including the default aggregation factor value, and the default aggregation factor value corresponding to one or more second transmission configuration indication state identifiers that are not associated with any of the one or more identifiers.

Aspect 34: The network entity of any of aspects 29 through 33, where the one or more processors are further configured to cause the network entity to: output, via the control message, a transmission configuration indication state element, the transmission configuration indication state element including a field that indicates the aggregation factor value, the parameter associated with a transmission configuration indication state provided by the transmission configuration indication state element.

Aspect 35: The network entity of any of aspects 29 through 34, where the one or more processors are further configured to cause the network entity to: output, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Aspect 36: The network entity of any of aspects 29 through 35, where the one or more processors are further configured to cause the network entity to: output, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Aspect 37: The network entity of any of aspects 29 through 36, where the one or more processors are further configured to cause the network entity to: output, via the control message, an indication of an activation of one or more transmission configuration indication states, the parameter associated with a transmission configuration indication state of the one or more transmission configuration indication states.

Aspect 38: The network entity of aspect 37, where the control message includes an activation MAC-CE.

Aspect 39: The network entity of any of aspects 29 through 38, where the one or more processors are further configured to cause the network entity to: output, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

Aspect 40: The network entity of aspect 39, where each identifier of the one or more identifiers corresponds to a respective sounding reference signal resource indicator identifier of a set of multiple sounding reference signal resource indicator identifiers.

Aspect 41: The network entity of any of aspects 39 through 40, where each identifier of the one or more identifiers corresponds to a respective sounding reference signal resource indicator power control identifier of a set of multiple sounding reference signal resource indicator power control identifiers.

Aspect 42: The network entity of any of aspects 39 through 41, where the one or more processors are further configured to cause the network entity to: output, via the control message, an indication of a default aggregation factor value, the one or more aggregation factor values including the default aggregation factor value, and the default aggregation factor value corresponding to one or more sounding reference signal resource indicators that lack an association with any of the one or more identifiers.

Aspect 43: A method for wireless communication at a network entity, including: outputting a control message that indicates one or more aggregation factor values; outputting information indicative of a parameter associated with a directional communication between a UE and the network entity, the parameter corresponding to an aggregation factor value of the one or more aggregation factor values; and communicating with the UE in accordance with the aggregation factor value based on the parameter associated with the directional communication.

Aspect 44: The method of aspect 43, further including: outputting, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

Aspect 45: The method of aspect 44, where each identifier of the one or more identifiers corresponds to a respective transmission configuration indication state identifier of a set of multiple transmission configuration indication state identifiers.

Aspect 46: The method of any of aspects 44 through 45, where each identifier of the one or more identifiers corresponds to a respective set of transmission configuration indication state identifiers of a set of multiple transmission configuration indication state identifiers that includes the transmission configuration indication state identifier.

Aspect 47: The method of any of aspects 44 through 46, further including: outputting, via the control message, an indication of a default aggregation factor value, the one or more aggregation factor values including the default aggregation factor value, and the default aggregation factor value corresponding to one or more second transmission configuration indication state identifiers that are not associated with any of the one or more identifiers.

Aspect 48: The method of any of aspects 43 through 47, further including: outputting, via the control message, a transmission configuration indication state element, the transmission configuration indication state element including a field that indicates the aggregation factor value, the parameter associated with a transmission configuration indication state provided by the transmission configuration indication state element.

Aspect 49: The method of any of aspects 43 through 48, further including: outputting, via the control message, a set of multiple transmission configuration indication state elements, each transmission configuration indication state element of the set of multiple transmission configuration indication state elements including a field that indicates a respective aggregation factor value, the parameter associated with a transmission configuration indication state provided by a transmission configuration indication state element of the set of multiple transmission configuration indication state elements.

Aspect 50: The method of any of aspects 43 through 49, further including: outputting, via the control message, a transmission configuration indication state element, where the transmission configuration indication state element does not include a field that indicates the aggregation factor value, the parameter associated with a transmission configuration indication state provided by the transmission configuration indication state element, and the aggregation factor value corresponding to a default aggregation factor value based on the transmission configuration indication state element that does not include the field.

Aspect 51: The method of any of aspects 43 through 50, further including: outputting, via the control message, an indication of an activation of one or more transmission configuration indication states, the parameter associated with a transmission configuration indication state of the one or more transmission configuration indication states.

Aspect 52: The method of aspect 51, where the control message includes an activation MAC-CE.

Aspect 53: The method of any of aspects 43 through 52, further including: outputting, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

Aspect 54: The method of aspect 53, where each identifier of the one or more identifiers corresponds to a respective sounding reference signal resource indicator identifier of a set of multiple sounding reference signal resource indicator identifiers.

Aspect 55: The method of any of aspects 53 through 54, where each identifier of the one or more identifiers corresponds to a respective sounding reference signal resource indicator power control identifier of a set of multiple sounding reference signal resource indicator power control identifiers.

Aspect 56: The method of any of aspects 53 through 55, further including: outputting, via the control message, an indication of a default aggregation factor value, the one or more aggregation factor values including the default aggregation factor value, and the default aggregation factor value corresponding to one or more sounding reference signal resource indicators that are not associated with any of the one or more identifiers.

Aspect 57: An apparatus for wireless communication at a UE, comprising at least one means for performing a method of any of aspects 15 through 28.

Aspect 58: A non-transitory computer-readable medium storing code for wireless communication, the code comprising instructions executable by one or more processors to perform a method of any of aspects 15 through 28.

Aspect 59: An apparatus for wireless communication at a network entity, comprising at least one means for performing a method of any of aspects 43 through 56.

Aspect 60: A non-transitory computer-readable medium storing code for wireless communication, the code comprising instructions executable by one or more processors to perform a method of any of aspects 43 through 56.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
receive a control message that indicates one or more aggregation factor values;
receive information indicative of a parameter associated with a directional communication between the UE and a network entity, the parameter corresponding to an aggregation factor value of the one or more aggregation factor values; and
communicate with the network entity in accordance with the aggregation factor value based at least in part on the parameter associated with the directional communication.

2. The apparatus of claim 1, the one or more processors further configured to cause the UE to:
receive, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

3. The apparatus of claim 2, each identifier of the one or more identifiers corresponding to a respective transmission configuration indication state identifier of a plurality of transmission configuration indication state identifiers.

4. The apparatus of claim 2, each identifier of the one or more identifiers corresponding to a respective set of transmission configuration indication state identifiers of a plurality of transmission configuration indication state identifiers that includes the transmission configuration indication state identifier.

5. The apparatus of claim 2, the one or more processors further configured to cause the UE to:
receive, via the control message, an indication of a default aggregation factor value, the one or more aggregation factor values comprising the default aggregation factor value, and the default aggregation factor value corresponding to one or more second transmission configuration indication state identifiers that are not associated with any of the one or more identifiers.

6. The apparatus of claim 1, the one or more processors further configured to cause the UE to:
receive, via the control message, a transmission configuration indication state element, the transmission configuration indication state element comprising a field that indicates the aggregation factor value, the parameter associated with a transmission configuration indication state provided by the transmission configuration indication state element.

7. The apparatus of claim 1, further comprising:
an antenna array, the one or more processors further configured to cause the UE to:
receive, via the antenna array and the control message, a plurality of transmission configuration indication state elements, each transmission configuration indication state element of the plurality of transmission configuration indication state elements comprising a field that indicates a respective aggregation factor value, the parameter associated with a transmission configuration indication state provided by a transmission configuration indication state element of the plurality of transmission configuration indication state elements.

8. The apparatus of claim 1, the one or more processors further configured to cause the UE to:
receive, via the control message, a transmission configuration indication state element, wherein the transmission configuration indication state element does not include a field that indicates the aggregation factor value, the parameter associated with a transmission configuration indication state provided by the transmission configuration indication state element, and the aggregation factor value corresponding to a default aggregation factor value based at least in part on the transmission configuration indication state element that does not include the field.

9. The apparatus of claim 1, the one or more processors further configured to cause the UE to:
receive, via the control message, an indication of an activation of one or more transmission configuration indication states, the parameter associated with a transmission configuration indication state of the one or more transmission configuration indication states.

10. The apparatus of claim 9, the control message comprising an activation medium access control (MAC)-control element (MAC-CE).

11. The apparatus of claim 1, the one or more processors further configured to cause the UE to:
receive, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

12. The apparatus of claim 11, each identifier of the one or more identifiers corresponding to a respective sounding reference signal resource indicator identifier of a plurality of sounding reference signal resource indicator identifiers.

13. The apparatus of claim 11, each identifier of the one or more identifiers corresponding to a respective sounding reference signal resource indicator power control identifier of a plurality of sounding reference signal resource indicator power control identifiers.

14. The apparatus of claim 11, the one or more processors further configured to cause the UE to:
receive, via the control message, an indication of a default aggregation factor value, the one or more aggregation factor values comprising the default aggregation factor value, and the default aggregation factor value corresponding to one or more sounding reference signal resource indicators that are not associated with any of the one or more identifiers.

15. An apparatus for wireless communication at a network entity, comprising:
one or more memories; and
one or more processors coupled with the one or more memories and configured to cause the network entity to:
output a control message that indicates one or more aggregation factor values;
output information indicative of a parameter associated with a directional communication between a user equipment (UE) and the network entity, the parameter corresponding to an aggregation factor value of the one or more aggregation factor values; and
communicate with the UE in accordance with the aggregation factor value based at least in part on the parameter associated with the directional communication.

16. The apparatus of claim 15, the one or more processors further configured to cause the network entity to:
output, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

17. The apparatus of claim 16, each identifier of the one or more identifiers corresponding to a respective transmission configuration indication state identifier of a plurality of transmission configuration indication state identifiers.

18. The apparatus of claim 16, each identifier of the one or more identifiers corresponding to a respective set of transmission configuration indication state identifiers of a plurality of transmission configuration indication state identifiers that includes the transmission configuration indication state identifier.

19. The apparatus of claim 16, the one or more processors further configured to cause the network entity to:
output, via the control message, an indication of a default aggregation factor value, the one or more aggregation factor values comprising the default aggregation factor value, and the default aggregation factor value corresponding to one or more second transmission configuration indication state identifiers that are not associated with any of the one or more identifiers.

20. The apparatus of claim 15, the one or more processors further configured to cause the network entity to:
output, via the control message, a transmission configuration indication state element, the transmission configuration indication state element comprising a field that indicates the aggregation factor value, the parameter associated with a transmission configuration indication state provided by the transmission configuration indication state element.

21. The apparatus of claim 15, further comprising:
an antenna array, the one or more processors further configured to cause the network entity to:
output, via the antenna array and the control message, a plurality of transmission configuration indication state elements, each transmission configuration indication state element of the plurality of transmission configuration indication state elements comprising a field that indicates a respective aggregation factor value, the parameter associated with a transmission configuration indication state provided by a transmission configuration indication state element of the plurality of transmission configuration indication state elements.

22. The apparatus of claim 15, the one or more processors further configured to cause the network entity to:
output, via the control message, a transmission configuration indication state element, wherein the transmission configuration indication state element does not include a field that indicates the aggregation factor value, the parameter associated with a transmission configuration indication state provided by the transmission configuration indication state element, and the aggregation factor value corresponding to a default aggregation factor value based at least in part on the transmission configuration indication state element that does not include the field.

23. The apparatus of claim 15, the one or more processors further configured to cause the network entity to:
output, via the control message, an indication of an activation of one or more transmission configuration indication states, the parameter associated with a transmission configuration indication state of the one or more transmission configuration indication states.

24. The apparatus of claim 23, the control message comprising an activation medium access control (MAC)-control element (MAC-CE).

25. The apparatus of claim 15, the one or more processors further configured to cause the network entity to:
output, via the control message, one or more identifiers associated with the one or more aggregation factor values, each identifier of the one or more identifiers associated with a respective aggregation factor value of the one or more aggregation factor values, and the parameter associated with a sounding reference signal resource indicator that corresponds to an identifier of the one or more identifiers.

26. The apparatus of claim 25, each identifier of the one or more identifiers corresponding to a respective sounding reference signal resource indicator identifier of a plurality of sounding reference signal resource indicator identifiers.

27. A method for wireless communication at a user equipment (UE), comprising:
receiving a control message that indicates one or more aggregation factor values;
receiving information indicative of a parameter associated with a directional communication between the UE and a network entity, the parameter corresponding to an aggregation factor value of the one or more aggregation factor values; and
communicating with the network entity in accordance with the aggregation factor value based at least in part on the parameter associated with the directional communication.

28. The method of claim 27, further comprising:
receiving, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.

29. A method for wireless communication at a network entity, comprising:
outputting a control message that indicates one or more aggregation factor values;
outputting information indicative of a parameter associated with a directional communication between a user equipment (UE) and the network entity, the parameter corresponding to an aggregation factor value of the one or more aggregation factor values; and
communicating with the UE in accordance with the aggregation factor value based at least in part on the parameter associated with the directional communication.

30. The method of claim 29, further comprising:
outputting, via the control message, one or more identifiers associated with the one or more aggregation factor values, each identifier of the one or more identifiers associated with a respective aggregation factor value of the one or more aggregation factor values, and the parameter associated with a transmission configuration indication state identifier that corresponds to an identifier of the one or more identifiers.
